(19) United States
(12) Patent Application Publication
(10) Pub. No.: US 2004/0117376 A1
(43) Pub. Date: Jun. 17, 2004

(54) Method for distributed acquisition of data from computer-based network data sources

(75) Inventors: James K. Lavin, Chicago, IL (US); Yingmei Lavin, Chicago, IL (US); Ben Tyler, Napa, CA (US)

Correspondence Address: James Lavin, 575 W Madison St, Apt 609, Chicago, IL, 60661, US

(73) Assignee: OPTIMALHOME, INC., Chicago, IL (US)

(21) Appl. No.: 10/604,345

(22) Filed: Jul. 14, 2003

Related U.S. Application Data
(60) Provisional application No. 60/319,392, filed on Jul. 12, 2002.

(51) Int. Cl. G06F 17/30; G06F 7/00

(52) U.S. Cl. 707/10; 707/3

(57) ABSTRACT

A method for facilitating efficient automated acquisition of data from computer-based network data sources, such as Internet websites, by means of one or more data aggregation servers and a distributed network of one or more client computers (each operated by and/or on behalf of one or more end users), that does not trigger “trespass on chattels” protection, violate copyright protection of database compilations of non-copyright data or allow data sources to easily detect automated data acquisition. In a specific embodiment, each user runs a java applet within their Internet browser that frequently polls a server connected to a database storing the user's preferences. Based on the user's preferences and other data stored in the database, the server generates requests (each to be issued by the client machine to a particular website) and tells the user's applet to issue those requests. Response(s) (or a processed version of those responses) returned to the server may be used by the client machine and/or returned to the server where they may be parsed, stored in the database, made available to the user (and, potentially, other users) and may trigger the server to generate follow-on requests. This method has many potential uses, including, but certainly not limited to, the aggregation of real estate data from numerous websites for homebuyers.

### CROSS REFERENCE To RELATED APPLICATIONS

This patent application claims the benefit of Provisional Patent Application No. 60319392 (“Method for distributed acquisition of data from computer-based network data sources”) filed on Jul. 12, 2002.

### COPYRIGHT STATEMENT

Copyright James Lavin, Yingmei Lavin, Ben Tyler, and OptimalHome, Inc. 2001-2003

### BACKGROUND OF INVENTION

1. Technical Field

This invention relates to the distributed acquisition of data from websites and other computer-based network data sources.

2. Background of the Invention

So much information is available on the Internet and other computer networks that finding data most appropriate to one's needs can be immensely time-consuming. Substantial manual search is typically required, and relevant data is often overlooked because it is spread so widely across numerous websites. Furthermore, sorting through and processing large quantities of information is time-consuming because information from diverse sources is not aggregated and standardized into a single searchable or viewable format. The success of information aggregation sites such as Google, MSN.com, AOL, Yahoo! and eBay proves that it is often very valuable to collect such information in a single location and to standardize, personalize and/or make easily searchable aggregated data. However, because data-rich information sources (particularly searchable databases) are poorly indexed or completely ignored by search engines (the so-called “invisible Web” problem), such information can be easily overlooked.

Furthermore, those who seek to aggregate data from multiple websites confront numerous technical challenges. Take, for example, residential real estate. As useful as aggregating and personalizing data from numerous residential real estate sites would be, doing so is very challenging. Data relevant to each homebuyer's decision making process is spread across so many websites and exists in so many different databases (many of which are not even accessible over the Internet) and in so many formats that collecting that data, unifying it in one place and displaying it in a personalized manner using a standard display format is quite a technical challenge.

The present patent makes it easier and more efficient to aggregate such dispersed data. Doing so facilitates the ability of individual users to access large quantities of data via a single, easy-to-use interface and personalized to address each user's particular needs by presenting precisely the information each user needs at precisely the moment they need it.

Eight important benefits desired by many end users who use electronic mechanisms (such as the Internet) to acquire data are:

Time savings because data aggregation into a single database that can be accessed via a single user interface minimizes the need to visit multiple sources to access all data.

More efficient data acquisition from websites because only one end user need acquire a piece of data from any given website (during any time period during which that data is considered “fresh”), thereby eliminating many redundant data requests.

Ease of use because data standardization of data acquired from multiple sites permits acquired data to be viewed, sorted, and searched in a single format through a single interface.

Commentability, updateability, and shareability because data stored in a single location using standard formatting is more easily modified, commented, and ability to attach notes, update information, and share data and comments with other users

Personalization because data aggregation allows data to be presented selectively, based on what is most useful to any particular user at any particular moment.

Data reliability because the more information available, the easier it is to make informed judgments concerning which data is most reliable and accurate. Inferences can be drawn about the quality of various information sources when information found through various sources can be compared and constrasted. Only data deemed most reliable need be presented to the end user. Or, all data may be displayed but with an indication regarding its perceived reliability.

Data freshness because the more data sources are consulted on a regular basis, the sooner new information is likely to become known.

Timely notification of important new or changed information without overwhelming users with frequent informational updates because the aggregated, personalized datasource will know which new or changed information is likely to be of particular interest to a particular user. The user can determine how many notifications they wish to receive each day or week and the aggregated, personalized datasource could determine which new information to push to each user. This approach avoids sending duplicate data and avoids overwhelming each user while ensuring that they get rapid notification of the most useful new or changed information.

Since similar benefits could arise by aggregating data on and finding patterns in many subject areas (e.g., real estate, resumes, plane tickets, news stories, identification of potential terrorists), the efficiency benefits of and the technical and legal challenges avoided/surmounted by the present invention are of substantial value to many other subject matters and industries.

Many developers have written programs that automate the aggregation of data from websites or legacy mainframe systems. The term “scraping” generally refers to the act of identifying desired data stored or displayed in another data source, extracting the raw data from the presentation format (a.k.a., extracting content from structure), and storing the raw data in one's own database. While “scraping” has been around for years, our June 2001 invention of “distributed scraping” is entirely new. As late as May 26, 2002, searches on Google.com for “distributed scraping” and “distributed screen scraping” generated the rare messages, “Your search . . . did not match any documents.”

Because many websites do not want their data aggregated and made available by other data providers, automated acquisition of data from public websites has engendered substantial controversy. Websites have employed and continue to employ numerous mechanisms intended to prevent others from acquiring the website's data through automated “scraping” of data by automated data acquisition programs, often informally termed “robots,” “bots,” or “spiders.” Methods intended to prevent automated data acquisition include:

1) Invoking the legal doctrine of “trespass on chattels” that prohibits certain forms of access to certain private property. Some courts have ruled that, in some situations, accessing private property, perhaps even intangible private property such as a publicly accessible Internet website, against the wishes of its owner constitutes an illegal infringement on private property rights. (Other courts and strong dissenting opinions have argued that public websites are, by virtue of their intrinsically public nature, not subject to trespass on chattels protection. And the Ninth Circuit Court of Appeals' ruling that websites may legally post thumbnail-sized images from other websites against the website owners' will implicitly grants to screen scrapers the right to access public websites against the website owners' will. Private property protections hwere nvoked successfully by,fBay which successfully forced Bidder's Edge' to cease its repeated and unwanted data scraping of its website by Bidder's Edge's automated “bots.”

2) Invoking copyright protections, either of the individual pieces of data underlying the database or of the compilation of data in aggregate (based on the creativity purportedly required to select, arrange and/or organize the data compilation).

3) Technical countermeasures to detect and shut out automated “bots.”

“Trespass on Chattels”

Individual pieces of data (especially facts and government data) may, by themselves, be unprotectable under copyright laws and available on the Internet, but it may still be illegal to use certain means of acquiring that data over the Internet because those means may constitute “trespass on chattels,” “chattels” being the computers holding the data.

The primary rationale for the court's ruling on “eBay v. Bidder's Edge” is that scraping harms the scraped websites by increasing the cost of doing business. Some courts have maintained that because servers that serve up webpages are private property, websites have the right to deny access to those who access their sites because too-frequent access causes harm to those sites by slowing down the servers and forcing the website owner to purchase additional servers to keep their site accessible and quick.

Copyright Protection of Database Compilations

Factual data is not copyrightable. Government data is not copyrightable. However, the aggregation of non-copyrightable data can, in its collectivity, be protected by copyright if its selection, arrangement, and/or organization involved creativity.

On the theory that creativity is involved in selecting, arranging and/or organizing a useful collection of data, database collections may receive copyright protection even if the individual facts underlying the data are not, by themselves, copyrightable. Under certain conditions, such copyright protection may provide grounds for preventing data scraping, especially by “bots” designed to systematically scrape a large percentage of a website's data.

Technical Countermeasures

Websites have attempted to distinguish between human beings accessing their site and automated “bots.” Once a “bot” has been detected, attempts can be made by websites to shut out the “bot.”

“Distributed scraping” has the additional potential benefit of making it harder for data sources to differentiate between automated and non-automated access in order to permit non-automated access while blocking automated access. If a data source is open to public access and if that data is not protected by copyright, the “distributed scraping” invention described herein should be able to acquire and aggregate that information, notwithstanding “trespass on chattels,” copyright protection of database collections or technical countermeasures.

### DESCRIPTION OF PRIOR ART

1) Gator (Gator.com): Similar to the present invention, Gator involves a server, client and one or more 3rd party websites. But Gator's purpose is not the aggregation of information from 3^{rd} party websites. Gator is instead interested in learning the interests of the web surfer and serving them appropriately timed ads based on their surfing behavior. Gator uses a client-server architecture. A program installed on a client machine (belonging to an end user) communicates with the Gator server. Gator detects when a user visits a particular website, presumably by having the client send messages to the server regarding which website the user is currently viewing. The Gator server can then serve to the user's browser a targeted ad, perhaps for a product competitive with or related to the content of the visited website and/or to previously visited websites. The only registration information Gator stores is the user's first name, country and state/zipcode. But it also captures surfing behavior. But Gator studies each user's surfing behavior for patterns, but it does not seek to aggregate information about 3rd party websites for the purpose of displaying it to other users.

2) Yodlee (Yodlee.com): Yodlee uses screen-scraping to aggregate data from various websites. But the aggregated data is all for a single user and is never shared with other users. Also, Yodlee's servers appear to scrape the data in a server-to-server fashion without using client machines as intermediaries. Each Yodlee user provides Yodlee with their personal account numbers, usernames, passwords, website addresses, etc. for some or all of their various online financial service (and some non-financial service) providers. Yodlee then (apparently) visits those sites using the information provided and uses screen scraping to aggregate the information on its own servers so each user can view their personal information more easily and more holistically. It also facilitates user interaction with their various accounts from a single view with standardized layout and formatting. Yodlee is not involved in data aggregation from multiple users. To the contrary, Yodlee assures users that their consolidated personal data will be visible only by the user herself or himself. Yodlee explicitly states that its own employees cannot view the data. Yodlee appears to connect to 3rd party websites server-to-server rather than through the user's machine(s).

3) Curl application: Curl is a new programming language. One example of the language's usefulness describes an application that can go to a search engine website (Google.com), then parse each returned listing until it finds an image that it then displays on the user's application window: “This demonstrates how you can use ‘screen scraping’ to get some interesting effects. A word or phrase is entered, and then that string is passed to www.google.com. Each listing on the first page is parsed until an image is found, and that image is then shown.” (http://www.curlexamples.com/view-source.php?example _id=159)

4) “Using Applets as Front Ends to Server-Side Programs”: The example in the Core Web Programming PDF file “Using Applets as Front Ends to Server-Side Programs” (http://notes.corewebprogramming.com/instructor/Server s-and-Applets.pdf) demonstrates an application that can go to multiple search engine websites, issue the same user query on each site and then display the results of each query within a portion of the user's application window. “Using Applets as Front Ends to Server-Side Programs” also describes how queries of different users can be sent to a central server-based application and displayed to other users. So, by routing user actions through the central server and routing it back out to other users, User A is able to see queries issued by User B. But the information passed among users relates exclusively to each user's behavior, not to the 3^{rd} party website information they retrieve. No mention is made of 3^{rd} party website information being stored on the central server. In neither the Curl example nor the Core Web Programming example is there any aggregation on a separate server of data returned by multiple user computers from 3^{rd} party websites. Each user is an isolated information silo. Nor is there any reduction in the load placed on 3^{rd} party websites by reducing the aggregate number of queries issued for all the users with partially-overlapping preference profiles.

5) Sidestep (Sidestep.com): Sidestep users install a browser plug-in into their browser. The plug-in communicates with Sidestep's servers, but not with 3rd party websites directly. Even if Sidestep's plug-in were to connect client machines directly to 3rd party websites, the purpose would not be to acquire data to store in a database for the benefit of other users interested in that data because the time-varying travel data Sidestep collects changes constantly. When a Sidestep user tells Sidestep's plug-in that it wishes to book a hotel or car in a certain city on a certain date or wishes to fly between two cities on a certain date, Sidestep issues simultaneous parallel queries to many online hotel or car rental or airline reservation systems. It then displays the results of those searches to the user and allows them to accept any of the offers. The results of Sidestep queries are not cached for the use of other users (though Sidestep may record some of that data for data mining or statistical analysis purposes). Caching such data would make little sense because it is “fast-changing” data, i.e., the underlying data changes frequently. Presenting User A's search results to User B might mislead User B because the data may have changed in the time between User A's query and User B's query. This is true of airfares because airlines adjust prices frequently to maximize profits. Generally, the fewer seats are available and the closer to the date of the flight, the more expensive the ticket. However, seats on relatively empty flights may become quite cheap at the last minute. And airlines may adjust their price in response to some other airline adjusting its price. The price quoted to one potential buyer for the same seat may be different than the price quoted to another potential buyer for the same seat due to the day and time of other legs of their proposed itineraries. It's extremely confusing, even to frequent fliers. Sophisticated time-based price models used by airlines make it impractical for Sidestep to cache results. The same is true of hotels that may or may not book up and may, therefore, systematically adjust their rate over time as the likelihood of booking up fluctuates with changes in anticipated demand. A hotel may also offer discounts to visitors who are staying longer. Car rental companies may or may not change their prices, but they certainly encounter availability problems where cars of certain classes become unavailable. Near-real time data that is time-sensitive and goes stale quickly is not information that can or should be re-used by other users. For this reason, Sidestep could not use this invention to reduce the load it places on 3rd party websites unless it had users issuing exactly the same queries at virtually the same exact instant.

6) Cooperative/friendly websites: Web services: “Web services” are increasingly popular. A web service is a 3^{rd} party website that is designed to receive requests formatted according to particular predefined rules and to process that information and return information relating to each request. Web services are designed with clear interfaces for communication and coordination. These interfaces are predefined, published and known to all users of the web service. Thus, a 3^{rd} party website offering a web service is cooperative or friendly with its users. Also, web services are typically computer-to-computer protocols, not computer-to-human protocols. Data transmitted from a web service computer to the requesting computer is typically passed as raw, structured data without presentation or display rules (via XML) designed for the receiving computer to parse and make use of. Generally, data is not passed as HTML immediately viewable by a human user. If an application programming interface (API) on the 3rd party website is programmed to accept and react to a visit from a client, then the client and two servers can obviously cooperate with one another. Unlike the present invention, web services presuppose that the 3^{rd} party website serves data in a cooperative or friendly manner with the data acquiring application. The quotation below uses the example of Outlook Express: “The java applet can get the data from a website other than from where it is downloaded. All you have to do is to have some server program on that web site from where you intend to get the data. The server program will serve the requested data to the applet. It is like some x party is implementing some server Object with some services and they are specifying the mode of accessing the data rather you should say a mode of calling the services which will serve the data. Now any one can write their client object (applet) to access the data. Example: Microsoft Outlook Express mail client can login to any mail server (whichever you specify) and can retrieve your mails.” (“How can a java applet get data from a website which is different from the location it was downloaded from?” Q4064, http://developer.irt.org/script/4064.htm)

7) Cooperative/friendly websites: data with “type” information: U.S. Pat. No. 6,138,148 is “Client intermediation of server applications” (assignee: Sun Microsystems). Sun's patent has two servers with a client in between, but it presumes a common language spoken by the two servers that allows the client to determine how to route the message based on the message itself. Websites can cooperate by encoding “type” information into messages they pass. This “type” information acts analogously to address or delivery information on a letter or parcel. Unlike address information, however, “type” information might not indicate only one recipient. “Type” information can, instead, indicate the type of recipient. It might say, for example, “Send me to a credit card company for processing” or “Send me to your bank for processing.” “Type” might be the equivalent of processing instructions. In Sun's invention, “type” information is embedded into each message. So, sites can cooperate with one another by tagging messages with “type” information. Sufficient “type information” is assumed to be embedded in the “composite message” to allow the client to route the message to another server. In other words, Sun's patent is for the friendly use of intelligent messages written in a lingua franca that permit routing of those messages to other servers. As its abstract states, “The method uses the type information to look up a network address of the application residing on the second server computer system. This address is used to forward the composite message to the application on the second server computer system. . . . This type information is used to look up an address of a source application on the network, and this address is used to forward the return composite message to the source application.” Our patent is for the hostile use of dumb information that the sending server does not intend to be re-routed or re-used for other purposes other than for viewing on the client machine.

8) Embedded references in XVRL documents: Another data scraping method is XVRL (http://www.xvrl.org/).“extensible Value Resolution Language (XVRL) enables XML authors to refer to external and dynamic data in their XML documents. When an XVRL parser parses an XVRL document, it resolves the external data references to produce an ordinary XML document that contains fully resolved values. From their XVRL documents, XML Authors can get the current time, extract data from databases, and “scrape” data from web pages. Programmers can integrate virtually any external data sources by writing their own resolver classes.” The type of “scraping” described appears to be little more than creating in the XVRL document a pointer (or “reference”) to a location on a website and replacing the pointer with the current value on the 3^{rd} party website when the XVRL page is rendered. This is not intelligent, systematized data scraping.

9) OnePage's Content Connect Studio: Similar, but more sophisticated than XVRL, is OnePage's Content Connect Studio (http://www.onepage.com/viewdemos.html). OnePage has a product that allows a user to manually “surf” to any webpage using their browser, click on any piece of information on that page and to schedule regular updates of that information. The program will thereafter go grab the data and make it available to the user without need for the user to revisit the website. OnePage (http://www.onepage.com/technology.html) describes this as a three-step process: 1. Navigate to desired content 2. Select content by clicking on it 3. Choose format “OnePage software is built on a patent-pending core technology for identifying, extracting and retrieving information. The core technology reflects a breakthrough approach to creating dynamic information components from any web-accessible source.” Its FAQ says, “This technology combines high-performance pattern-matching techniques and sophisticated feature extraction algorithms with a proprietary object-oriented statement language, providing the full power of a scripting language in a simple, flexible single-string URL.” (http://www.onepage.com/faq.html) “OnePage represents an evolution of the screen scraper to an intelligent form. Unlike screen scrapers, OnePage technology is not dependant on the position of items on a page as a means of identifying the desired content. Rather, the OnePage technology employs artificial intelligence and sophisticated pattern matching algorithms to mark and identify the exact information you need on any given web page. This is critical because it provides you (1) the ability to select and use more granular pieces of information from a web page and (2) greater reliability and confidence that the information you need will be retrieved for you.” (http://www.onepage.com/faq.html) “The strength of OnePage technology is its resilience to any changes on the source page. When information is selected on a web page, OnePage core technology marks the information itself rather than the position of that information on the page. Therefore, if information on a page is relocated, OnePage will still be able to identify and utilize the information.” (http://www.onepage.com/faq.html) OnePage's technology requires that users manually schedule data collection by “surfing” to desired content and selecting it. No data aggregation across users is involved. OnePage is similar to XVRL or Yodlee in this respect.

10) Screen scraping of data stored on legacy mainframes: There are many applications that try to make data stored on legacy mainframe computers more accessible by scraping it off of the “green screen” mainframes and displaying that data using more modern display techniques, such as HTML over the Internet. Several examples include: “Screen scraping runs scripted client software which interacts with legacy green screen applications e.g. CICS 3270 terminal apps, and (through the scripting) can return data to a host component. The host component can make the data available to non-legacy apps through ODBC, JDBC, etc.” (http://mindprod.com/jglosss.html) Ritu Chadha of Bellcore's “Integration of Web with Legacy Systems Through Java Applets and Distributed Objects” (http://www.objs.com/workshops/ws9801/papers/paper 032.html) David Wright's “A Design/implementation Process,” February 2000 (http://www.millennium-3.net/downloads/artel.doc): “There are four main application characteristics that might fall into the client/server environment . . . Existing mainframe application with a front end GUI applied (screen scraper).” Persona's “Overview Data Sheet” (http://www.esker.com/Q300/products/host_access/persona/DS_P_Oview_{—}010119.pdf) says, “Windows NT/2000 Server-based Persona web-to-host connectivity software delivers precise terminal emulation and versatile access to data and applications residing on multiple host computing system types: IBM mainframe, AS/400, Unix, Digital, and Data General. Featuring centralized administration and interface customization capabilities, Persona offers reliable and efficient extranet/Internet access to enterprise information . . . . For 3270 and IBM 5250 emulation, Persona's Dialog View can turn the IBM “green screen” into a Windows-like graphical interface that gives host applications a consistent and familiar appearance to enhance user productivity.” Bull's “Web-to-GCOS Panorama of the Solutions” (http://www.servers.bull.com/netgcos/download/en_pano ram_{—}2.pdf) depicts a “User station (browser)” connecting to a web server that is connected to an internal network. The internal network consists of a “HTML converter & screen-scraper” that sits between the web server and a “Communications server” that interacts with a “GCOS” via “DSA.” “A first level of Web-to-Host tools is what is known as Web terminal emulators. They provide access to existing applications using a browser without having to reformat the information. For example, terminal emulation may be built as a Java applet or an ActiveX control.” “A second level of Web-to-Host tools provides the faculty to revamp the way information is presented. This affords graphic improvement of the presentation but also merging or separating of screens, enhancing them and accessing where required of several host applications from the same presentation. The host applications remain unchanged, only the visibility for the user is modified. As the information is reformatted and enriched, this type of tool is particularly suitable for new users, particularly those external to the company who need a user friendly and attractive application interface.” “A third level of Web-to-Host tools offers the faculty to change the presentation of resident transactional applications within the application without using an intermediate screen conversion and management tool.”

11) Link extraction tools: U.S. Pat. No. 6,185,701 is an “Automated client-based web application URL link extraction tool for use in testing and verification of internet web servers and associated applications executing thereon.” This relates to testing and verification of web servers, not automated data collection and aggregation. U.S. Pat. No. 6,334,145 is a “Method of storing and classifying selectable web page links and sublinks thereof to a predetermined depth in response to a single user input.” This is “dumb” scraping in which no effort is made to understand or to parse the accessed webpages except to find additional links to scrape.

12) Server stress testing tools: U.S. Pat. No. 6,157,940 is an “Automated client-based web server stress tool simulating simultaneous multiple user server accesses.” This relates to web server stress testing, not automated data collection and aggregation. U.S. Pat. No. 6,044,398 is a “Virtual dynamic browsing system and method for automated web server and testing.” This relates to testing and verification of web servers, not automated data collection and aggregation.

13) Intelligent agents: U.S. Pat. No. 6,304,864 is a “System for retrieving multimedia information from the internet using multiple evolving intelligent agents.” This relates to multiple evolving intelligent agents. With multiple intelligent agents, the intelligence about which websites to visit and how to interpret returned data resides on the client application, not on the centralized server.

14) Data push from server to client: U.S. Pat. No. 6,286,031 is a “Scalable multimedia distribution method using client pull to retrieve objects in a client-specific multimedia list.” This relates to pushing data out to users, not pulling data in from 3^{rd} party websites.

15) Data push/pull from client to client: Patent application # 20010027479 is a “Distributed client-based data caching system.” This describes “A system and method for enabling data package distribution to be performed by a plurality of peer clients connected to each other through a network, such as a LAN (local area network). Each peer client can obtain data packages from each other or from an external server. However, each peer client preferably obtains data packages from other peer clients, rather than obtaining data packages from the external server.” This relates to distributing data across users, not aggregating data from 3^{rd} party websites.

16) Distributed processing: Patent application # 20010011294 is “Commercial distributed processing by personal computers over the Internet.” This describes distributed data processing, not distributed data acquisition and aggregation.

U.S. Pat. No. 6,334,145 “Method of storing and classifying selectable web page links and sublinks thereof to a predetermined depth in response to a single user input” is simply automated “dumb” link crawling.

U.S. Pat. No. 6,304,864 “System for retrieving multimedia information from the internet using multiple evolving intelligent agents” involves evolving intelligent agents.

U.S. Pat. No. 6,044,398 “Virtual dynamic browsing system and method for automated web server and testing” relates to testing and verification of web servers.

U.S. Pat. No. 6,157,940 “Automated client-based web server stress tool simulating simultaneous multiple user server accesses” relates to web server stress testing.

U.S. Pat. No. 6,185,701 “Automated client-based web application URL link extraction tool for use in testing and verification of internet web servers and associated applications executing thereon” relates to testing and verification of web servers.

U.S. Pat. No. 5,675,637 “Method for automatically obtaining and presenting data from multiple data sources” relates to service centers, not a client scraping websites.

### SUMMARY OF INVENTION

This invention provides a means for efficient automated acquisition of data from public websites on behalf of individual users, based on each user's preferences, and (if desired) for the collection and aggregation of some or all of that data in another database without violating “trespass on chattels,” invoking copyright protections of a data collection, or allowing websites to detect and shut out the automated data acquisition. Efficiency in gathering information is enhanced by the automation of searches based on each user's personal preferences (thereby reducing manual human effort in identifying websites, filling in forms manually, and going back to websites frequently to check for new or updated information) and by reducing the number of redundant queries issued by multiple users in a short period of time (because data retrieved by one user can be stored and shared with other users without re-issuing the query to the original data source every time any user wants that data). This invention, by making it easier to aggregate data/information from multiple sources, also makes it easier to personalize, keep fresh, comment on, share, and provide timely notification of additions or changes to that data/information.

The term “Peer to Peer” or “P2P” has gained widespread recognition. Using this shorthand notation for the flow of data across computers, our unique data acquisition method might (far less mellifluously) be summarized as “Server to Peer to Server to Peer to Server” or “S2P2S2P2S” which summarizes the 4-step flow of data:

Step 1: Server A to Peer: a data aggregation server (Server A) sends one or more specific or non-specific requests [defined later], incorporating any end user preference profile information available to the data aggregation server, to a cooperating data acquisition application sitting on an end user's computer (the Peer);

Step 2: Peer to Server B: the data acquisition application (Peer) issues, via a computer network, a request to Server B, a non-cooperating 3rd party data source (such as an Internet web server) holding the desired data, perhaps after making the request more specific based on end user preference profile information available to the data acquisition application;

Step 3: Server B to Peer: 3rd party data source (Server B) sends a response to the data acquisition application (Peer);

Step 4: Peer to Server A: the data acquisition application (Peer) may or may not use some or all of the returned data (in raw or transformed format), and it re-transmits that data (or some subset of that data) back to the data aggregation server (Server A).

Hence, we can tersely summarize this as “S2P2S2P2S” because data (albeit different data at each step) passes from Server A to Peer to Server B to Peer and back to Server A.

The invention collects data from many peers and then enables the redistribution of that data to other users (“peers”). At any time after the non-copyrightable data has been aggregated, an end user (or the end user's client interaction application) wishing to access data stored on the data aggregation service may issue a request to the end user interaction application on the data aggregation service and the end user interaction application will return the appropriately formatted data to the client interaction application.

A variant of this method is the 3-step “Server to Peer to Server to Peer” or “S2P2S2P” process whereby data returned to the Peer from Server B is stored or used by the Peer but not passed back to Server A. This might be useful if, for example, the end user were legally able to view and/or use the data for their personal use but were not legally able to share the data acquired from Server B with others. In this case, data aggregation occurs on each end user's computer.

Given these two variants, the most precise summary description of the present invention is “Server to Peer to Server to Peer (to Server)” or “S2P2S2P(2S).”

### BRIEF DESCRIPTION OF DRAWINGS

FIG. 1 lays out a typical network hardware architecture over which the processes described in this invention occur.

FIG. 2 is a flow chart of the step-by-step process by which the Data Aggregation Service, Data Acquisition Application and 3rd Party Website interact to collect data when the Data Acquisition Application pulls requests from the Data Aggregation Service and the end user profile resides on the Data Aggregation Service.

FIG. 3 is a flow chart of the step-by-step process by which the Data Aggregation Service, Data Acquisition Application and 3rd Party Website interact to collect data when the Data Aggregation Service pushes requests to the Data Acquisition Application and the end user profile resides on the Data Aggregation Service.

FIG. 4 is identical to FIG. 2 except that the end user profile resides on the client machine, not the Data Aggregation Service.

FIG. 5 is identical to FIG. 3 except that the end user profile resides on the client machine, not the Data Aggregation Service.

FIG. 6 is a flow chart describing the data acquisition and aggregation process in greater detail than FIG. 2 and FIG. 3, with particular emphasis on processing and data storage within the Data Aggregation Service. Because our exposition should be clear, we omit the obvious figure that would have been identical to FIG. 6 except that the preference profile would have resided on the client machine, analogous to the difference between FIGS. 4 and 2 and FIGS. 5 and 3.

FIG. 7 is a flow chart describing the data acquisition and aggregation process in greater detail than FIG. 2 and FIG. 3, with particular emphasis on the interaction between components residing on the Client Machine and the Data Aggregation Service. Because our exposition should be clear, we omit the obvious figure that would have been identical to FIG. 7 except that the preference profile would have resided on the client machine, analogous to the difference between FIGS. 4 and 2 and FIGS. 5 and 3.

FIG. 8 is a flow chart describing an alternative method for distributed data collection that relies on a Data Acquisition Application process listening on the Client Machine to data passing between an end user's browser session and 3rd Party Websites rather than automated scraping of web pages by the Data Acquisition Application.

### DETAILED DESCRIPTION

This invention provides a means for efficient automated acquisition of data from public websites on behalf of individual users, based on each user's preferences, and (if desired) for the collection and aggregation of some or all of that data in another database without violating “trespass on chattels,” invoking copyright protections of a data collection, or allowing websites to detect and shut out the automated data acquisition. Efficiency in gathering information is enhanced by the automation of searches based on each user's personal preferences (thereby reducing manual human effort in identifying websites, filling in forms manually, and going back to websites frequently to check for new or updated information) and by reducing the number of redundant queries issued by multiple users in a short period of time (because data retrieved by one user can be stored and shared with other users without re-issuing the query to the original data source every time any user wants that data). This invention, by making it easier to aggregate data/information from multiple sources, also makes it easier to personalize, keep fresh, comment on, share, and provide timely notification of additions or changes to that data/information.

The present invention circumvents all three above-described means commonly used to protect data on publicly accessible websites:

Trespass on Chattels:

Some courts have held that “trespass on chattels” can, under certain circumstances, protect even publicly accessible websites, though there have been vigorous minority opinions opposing this view, so the legal status of this doctrine is still somewhat unsettled.

Regardless of the eventual outcome of the legal debate over the applicability of “trespass on chattels” to data “scraping” in general, the doctrine is not applicable to the present invention because the present invention simply automates the process of requesting information that an individual user can and must otherwise request manually. Websites are generally designed and built to provide information to individuals seeking that particular information. The present invention includes features that make it easier for such individual users to acquire such information. Requests issued manually and requests issued by the process described in this invention both issue from client computers to 3rd party websites and are indistinguishable. The only difference is whether the request was issued by the user directly (by hand) or indirectly (by the invention, based on the end user's informational needs and preferences).

Below, we list the specific legal issues cited in court decisions on “eBay vs. Bidder's Edge” (hereafter, “Bidder's Edge”) and “Intel Corporation v. Kourosh Kenneth Hamidi” (hereafter, “Intel”; filed 10 Dec. 2001, Court of Appeal of the State of California, Third Appellate District) in which courts ruled that trespass on chattels applied in cases of automated sending of email (“Intel”) and automated acquisition of data from websites (“Bidder's Edge”).

Harm to servers by automated data acquisition: The principal principle of majority decisions in the aforementioned legal cases is that automated website scraping imposes a burden on website servers by increasing the number of requests they receive and the number of responses they must generate.

In “Intel,” the court pointed out that the defendant “repeatedly flooded Intel's e-mail system . . . and on several occasions sent e-mail to up to 29,000 employees.” The courts similarly ruled in “eBay, Inc. vs. Bidder's Edge, Inc.” (pub.bna.com/lw/21200.htm) that repeated, automated visiting of a website for the purpose of taking its data could be prohibited due to the harm that would be inflicted on the visited website if many firms chose to frequently “scrape” its data:

“[T]here is a legitimate claim that [Bidder's Edge's] robots would not pose any threat of irreparable harm. However, eBay's right to injunctive relief is also based upon a much stronger argument. If BE's activity is allowed to continue unchecked, it would encourage other auction aggregators to engage in similar recursive searching of the eBay system such that eBay would suffer irreparable harm from reduced system performance, system unavailability, or data losses . . . . If eBay's irreparable harm claim were premised soley on the potential harm caused by BE's current crawling activities, evidence that eBay had licensed others to crawl the eBay site would suggest that BE's activity would not result in irreparable harm to eBay. However, the gravamen of the alleged irreparable harm is that if eBay is allowed to continue to crawl the eBay site, it may encourage frequent and unregulated crawling to the point that eBay's system will be irreparably harmed.” (U.S. District Court for the Northern District of California, “eBay, Inc. vs. Bidder's Edge, Inc.”, No. C-99-21200 RMW, pub.bna.com/lw/21200.htm.)

Frequent accessing of websites imposes a significant financial burden on the owners of such servers. Because the courts generally (though not universally) consider servers to be private property (even if those servers are serving up webpages to the public), the burden imposed by “bots” supposedly constitutes trespass on chattels.

Based on this reasoning, “trespass on chattels” does not apply to the mechanism described in the present invention because the present invention generally REDUCES the overall load on 3rd party website servers compared with the load those computers would sustain in the absence of this invention since each individual user, in the absence of this invention, might access the publicly accessible website whereas the present invention reduces the need for all users to independently access data by eliminating many redundant information searches. The overall load on 3rd party websites is reduced because overlapping preferences of end users combined with server-based sharing of data returned by clients to the server results in a reduction in the total number of pages that must be accessed for all end users to have access to all relevant data. The greater the extent of overlapping preferences, the greater the reduction in webpages that must be served. If ten users have identical preferences, the relevant pages need be acquired only once, not ten times. Our distributed network of data acquisition applications, therefore, reduces server load to the extent that end user preferences overlap. Load reduction applies even in the case of a single user to the extent that that user requests to view the same information multiple times, as often happens when information is of interest.

As the number of end users using the invention grows larger, the load placed on 3rd party websites actually declines because data returned from 3rd party websites may be stored on the data aggregation service and shared with all other users. There is no reason for different end users to request the same information multiple times in a short period of time. For any given data acquisition time interval for which each end user is willing to deem data acquired during that time interval “fresh enough” (whether week, day, six hours, hour, etc.), each piece of data can be collected only once by any one user and thereafter reused by all users without need to reacquire the piece of data from its original source. Since the information collected is stored in our database, it can be shared with all users who request to view that home during the time interval, rather than have each user visit the home again. Consequently, the harm that justified locking out Bidder's Edge does not apply in the case of this invention since the individual searches are legitimate and the load on the 3rd party website would be lower.

To summarize, the court stated in “Intel” that “We accept that ‘The plaintiff, in order to receive more than nominal damages, must prove the value of the property taken, or that he has sustained some special damage.’” The present invention causes no damage because what is taken (i.e., non-copyrightable facts and governmental data) is not property of the original possessor. The invention merely allows users to access public web pages that are available publicly precisely for that purpose. Further, as pointed out above, the present invention REDUCES the overall load on public webservers, thereby reducing the cost of serving those pages to multiple users.

Owners of private property may exclude public use: In “Intel,” the court thought it relevant that Intel “maintains an internal, proprietary, e-mail system for use of its employees; the e-mail addresses are confidential.” The eBay case also made clear that websites have the legal right to exclude whomever they choose:

“BE argues that it cannot trespass eBay's web site because the site is publicly accessible. BE's argument is unconvincing. eBay's servers are private property, conditional access to which eBay grants the public. eBay does not generally permit the type of automated access made by BE. In fact, eBay explicitly notifies automated visitors that their access is not permitted. ‘In general, California does recognize a trespass claim where the defendant exceeds the scope of the consent.’ Baugh v. CBS, Inc., 828 F.Supp. 745, 756 (N.D. Cal. 1993).” (U.S. District Court for the Northern District of California, “eBay, Inc. vs. Bidder's Edge, Inc.”, No. C-99-21200 RMW, pub.bna.com/lw/21200.htm.)

The present invention does not facilitate systematic “crawling” or “scraping” of websites. Our invention requires a program (residing on each end user's computer) that simply automates the manual process each user would go through to view precisely the information they desire to see. This is public access by individual members of the public. From the perspective of information passing between the end user's computer and the 3rd party website, there is no difference between a series of webpage requests initiated directly by a human being and the identical requests initiated by the human being but mediated by a computer program sitting on their computer. Each user computer visits websites to access specific information closely related to the user's stated preferences, not broadly defined information unassociated with the end user's legitimate data needs. This invention is not designed to systematically grab large quantities of data. To the contrary, it is intentionally designed to minimize the frequency of access by end users, thereby reducing the load on 3rd party website computers. Consequently, the present invention will not trigger the “exceeding the scope of consent” doctrine mentioned in the eBay case:

“Even if BE's web crawlers were authorized to make individual queries of eBay's system, BE's web crawlers exceeded the scope of any such consent when they began acting like robots by making repeated queries. See City of Amsterdam v. Daniel Goldreyer, Ltd., 882 F. Supp. 1273, 1281 (E.D.N.Y. 1995) (‘One who uses a chattel with the consent of another is subject to liability in trespass for any harm to the chattel which is caused by or occurs in the course of any use exceeding the consent, even though such use is not a conversion.’). (“U.S. District Court for the Northern District of California, “eBay, Inc. vs. Bidder's Edge, Inc.”, No. C-99-21200 RMW, pub.bna.com/lw/21200.htm.)

In “eBay vs. Bidder's Edge,” eBay did not provide open access. As the court pointed out in its ruling against Bidder's Edge, “Users of the eBay site must register and agree to the eBay User Agreement . . . . Users agree to the seven page User Agreement by clicking on an ‘I Accept’ button located at the end of the User Agreement.” (U.S. District Court for the Northern District of California, “eBay, Inc. vs. Bidder's Edge, Inc.”, No. C-99-21200 RMW, pub.bna.com/lw/21200.htm.) Unlike eBay, websites that provide open access to the public (without a registration process) already grant users the implicit right to view such data. That is the apparent purpose of such public websites. Once a user's computer has legally accessed factual, non-copyrighted data, the user can use such data for whatever purposes, unless using the website requires completing a registration process requiring the user to consent to certain usage limitations (such as promising not to share the information).

Users who access websites open to the public but that limit or prevent sharing of that information through a registration process may still be able to use an automated acquisition process to acquire data for their personal use.

The present invention enables its users to access websites and to request webpages that match the user's preferences and that are, therefore, common uses of those websites by public users. Further, the present invention enables sharing of data with other users if that data comes from a public website that does not have a registration process restricting the user's ability to reuse the data. If the invention is ever used to gather data from sites that restrict data reuse, the invention could still store and/or display gathered data on the user's computer only and prevent the user's computer from re-transmitting such data to the data aggregation service.

In fact, the ruling in “Intel” explicitly distinguishes between public Internet websites and private email systems: “We recognize the open character of the Internet . . . . Private e-mail servers differ from the Internet; they are not traditional public forums. Nor is a private company which chooses to use e-mail made a public forum . . . . Intel invites the public to use its e-mail system for and only for BUSINESS PURPOSES.” (pp. 29 & 30)

Business disrupton: Intel won its case because it successfully “showed [the defendant] was disrupting its business by using its property . . . Intel . . . showed it was hurt by the loss of productivity caused by the thousands of employees distracted from their work and by the time its security department spent trying to halt this distraction [to] its internal, proprietary e-mail system.” “[T]he massive size of Hamidi's campaign caused Intel much trouble, not the least of which was caused by the lost time of each employee” (p. 31).

The present invention simply allows users of websites designed for public use to automate the process of visiting those websites. Individual user-scale automation of what is legitimate as a manual activity hardly constitutes a disruption to the public website's business since, from the website's perspective those activities are identical . . . a page request is made by the user's computer and a webpage is served to the user's computer.

“Trespass on chattel” should entail injury to the chattel itself An argument might be made that the present invention could harm a 3rd party website by allowing end users to acquire non-copyright data and view and use it in a manner unintended by the website. For example, the website might hope to generate revenue by displaying advertising alongside the data it displays. However, even if this were to be deemed a harm, any such harm would not be a harm to the chattel itself. This fact would rule out “trespass on chattels” protection. As the dissenting opinion in “Intel” pointed out:

“[I]t is not too much to ask that trespass to chattel continue to require some injury to the chattel (or at least to the possessory interest in the chattel) . . . The other appellate decisions that have applied trespass to chattel to computer systems have done so only where the transmittal of the unsolicited bulk e-mail burdened the computer equipment . . . or where the unauthorized search of, and retrieval of information from, another party's database reduced the computer system's capacity.” (“Dissenting opinion of Kolkey, J.” in the “Intel” case)

Owners are required to take reasonable steps to protect their chattels: There is also a general presumption that websites should take reasonable actions to protect their data if they wish to receive legal protection from “trespass on chattels”. Public websites are almost tautologically ineligible for “trespass on chattels” protection:

“California cases have consistently required actual injury as an element of the tort of trespass to chattel . . . The only possible exception to the requirement of actual injury is where there has been a loss of possession . . . Sufficient legal protection of the possessor's interest in the mere inviolability of his chattel is afforded by his privilege to use reasonable force to protect his possession against even harmless interference.” (“Dissenting opinion of Kolkey, J.” in the “Intel” case)

Copyright Protection of Databases:

Copying all the factual or governmental data from a website could possibly trigger copyright protection of factual compilations, even if the individual facts themselves are not copyrightable. This is true because creativity is the cornerstone of copyright protections and the courts have held that certain compilations require creativity in selectively and judiciously selecting, arranging and/or organizing the data.

The mechanism described in this invention avoids any copyright protection afforded to a data compilation on the basis of its collective nature or totality because:

No systematic effort is made to acquire all data from any website.

Individual end users acquire only a small percentage of data available on any website.

To the extent that copyright protection is provided to a compilation on the basis of the creative selection, arrangement or organization of facts, the present invention is even less likely to be subject to such copyright protection since the invention is designed to aggregate and standardize data from multiple sources. To the extent that different data sources present data differently, the process of aggregation and standardization necessarily changes the selection and throws away the original arrangement, formatting and organization. To the extent that different data sources present data similarly, a question arises concerning whether creativity was needed to determine how to select, arrange or organize the facts.

The present invention does not describe server-to-server data acquisition. Instead, it enables individual users to easily acquire the data they desire via their own computers. No individual user copies an entire database, or even a significant portion of a database. Each user simply acquires whatever facts they themselves require and/or desire for their personal usage. Such use of a public website's factual or governmental data is completely permissible . . . and exactly what each user would otherwise do manually and legally. Once an end user's computer has downloaded the slice of data relevant to that end user's wants and/or needs, the computer may send such data to the data aggregation service so that the data may be standardized, linked with other data, and personalized, thereby enhancing the data's value to the user. Such transformed, improved, personalized data may then be passed back to individual users.

Technical Countermeasures:

The distributed data acquisition mechanism described in this patent is more difficult for websites to detect than non-distributed, non-personalized “bots” because:

The distributed data acquisition mechanism is not a monolithic “bot” that sends requests from one or a few computers but a large number of application instances, one for each end-user, distributed across the Internet. When all requests come from a small number of computers, it is easier for a website to detect and deny access to the originating computer(s).

Each instance of the distributed data acquisition application (client-based “bot”) looks only for specific information that the end user who operates the client computer may look for manually. Thus, the requests are the same requests that might be made manually by the end user.

Client-based “bots” can be programmed with random, or even non-random, behavior (such as: random delays between HTML requests, requests for other pages to make it look as if the user had clicked on page links other than those pages she or he really wishes to view, long delays to simulate bathroom breaks, or clicking on links out of order), thereby mimicking the clickstream behavior of an individual Internet user and making it difficult for the website to detect and block automated data collection

### Definitions

“3rd Party Website” indicates any data source (such as a website on the Internet but not necessarily an Internet website) accessible via a computer network that responds to requests for information with informative, relevant responses (via an information transmission protocol such as an HTML response to an HTTP or HTTPS request).

A 3rd Party Website may or may not require that the user complete an online registration process and log in using a username, password or additional information before accessing the site. Legal issues may possibly limit the use of this invention to acquire data from a 3rd party website and/or to re-transmit acquired data to the Data Aggregation Service when the 3rd party website requires a registration process that restricts the ability of a user to access and/or distribute the data they access. One variant of this invention includes the ability for an end user to provide to the Data Acquisition Application information (such as usernames and passwords) it needs to access various 3rd party websites. The end user could provide such information by inputting it directly into the Data Acquisition Application every time the Data Acquisition Application needs it to access a 3rd party website or by storing it permanently on either the Data Acquisition Application or on the Data Aggregation Service. This issue is not considered further, beyond noting this potential legal limitation on the applicability of this patent.

Unless otherwise noted, “website” is equivalent to “3rd party website.”

“Log in” refers to the action of identifying and/or authenticating the identity of the computer, computer IP or MAC address, computer network IP or MAC address, and/or the end user (usually involving some combination of IP address, MAC address, username, password, “cookie” and/or email address) for purposes of granting or denying access to a website based on the identification and/or authentication. In all embodiments of the present invention, one variant includes the ability for an end user to provide registration information (such as a username and password that the end user uses to access any 3rd party website) either manually, immediately prior to accessing that 3rd party website, or by storing such information on either the client machine or the Data Aggregation Service for later use. Using either method, the registration information can be used to log the client machine into a 3rd party website before sending requests to that 3rd party website.

An “end user” is any person or persons who: 1) own and/or operate one or more computers; 2) desire to access data; 3) voluntarily install a Data Acquisition Application on their computer(s) to acquire such data.

“Agent” is any person or persons authorized by an end user to act on their behalf. All references in this patent application to an “end user” are intended to mean “end user or their authorized agent(s),” except when references clearly apply only to the end user, as when discussing end user preferences. Agents are assumed to take actions according with end user preferences; those preferences are the end user's, not the agent's.

An “end user preference profile” (or simply “preference profile” or “profile”) is an embodiment of an end user's informational needs and/or wants that is stored on and retrievable from either the client machine and/or the Data Aggregation Service. An end user's preference profile may also include access information required by 3rd Party Websites (such as usernames and passwords).

A “client machine” (or simply “client”) refers to any computer or computers used by one or more end users to acquire data from a 3rd Party Website and (possibly) return it to the server.

“Data Acquisition Application” indicates a computer program (or applet or any such program that runs on the client's computer or in their browser) that resides on the end user's computer that acquires data from 3rd Party Websites and may pass such data (or a modified or transformed version of such data) to the Data Aggregation Service.

“End user application” indicates any use of data collected by means of this patent, especially (but not limited to) an end user's use of any program(s) designed to aggregate, manipulate, transform, personalize and/or display data acquired via the distributed network of Data Acquisition Applications.

“Data Aggregation Service” indicates any computer or computers and all associated programs and data operated for the purpose of acquiring data from one or more websites in conjunction with one or more instances of client-based Data Acquisition Applications.

A “request” is an electronic message transmitted from one computer to one or more computers for the purpose of receiving an electronic response (or responses) related to the original request. An example of a request is an HTTP request made by an end user “surfing” the Web using a browser on a client computer. “Web surfing” is basically a series of HTTP requests and responses. One or more requests are transmitted as a result of clicking on a hyper-link or graphic, and the webpage or page elements that are returned constitute the HTTP response. An HTTP request is composed of a URL, header information, a method (GET or POST), and parameters.

A “non-specific request” is a partial request that lacks personalization information stored in the end user's preference profile. A non-specific request can be made specific by combining it with relevant information contained in the end user's preference profile. For example, a non-specific request using the “GET” HTML method might constitute a string of characters necessary to request that a particular real estate website return all homes in a particular town or zipcode without regard to house price, house square footage, house age, lot size, number of bedrooms, number of bathrooms, presence of a swimming pool, number of stories, etc.

A “specific request” is a request that embodies at least some personalization information captured in the end user's preference profile. A specific request includes any and all parameters needed to restrict the request to the queried website to include only results relevant to the end user's preference profile. For the example mentioned in the preceding paragraph, the GET method would include parameters restricting the town name and/or zipcode, the minimum and/or maximum house price, the minimum and/or maximum house square footage, the minimum and/or maximum house age, the minimum and/or maximum lot size, the minimum and/or maximum number of bedrooms, the minimum and/or maximum number of bathrooms, the presence or absence of a bathroom, a particular number of stories, etc., based on the end user's preference profile.

A “response” is an electronic message transmitted from one computer in response to a “request” made by another computer. An example of a response is an HTML response to an HTTP request sent over the Internet (or any other network connecting computers together). Responses need not be HTML. They could be any electronic message that is capable of being interpreted and stored by a receiving computer. Communication protocols of any kind that are “spoken” by two or more computers may be used to generate and interpret “requests” and “responses.” Examples include but are in no way limited to: binary code, text, images, images, sound files, DHTML, XML, etc.

A “Client-Specific Request Queue” is a location (such as rows in a database table) where requests generated by the Data Aggregation Service are placed (“queued”) for pick-up by a particular Data Acquisition Application or by any Data Acquisition Application belonging to an end user whose preference profile matches certain criteria relevant to the particular request. The queue is “Client-Specific” because requests are typically generated for a particular preference profile and should be picked up only by clients whose end user's profile match the preference profile criteria used to generate the request. The Client-Specific Request Queue may also be utilized as a storage location for responses received from clients that have processed a request and then returned the results to the Data Aggregation Service.

“Polling” is the act of regularly (typically periodically) contacting another computer (or another program or process residing on the same computer) to ask whether any new information is available. In this patent application, “polling” has a more specific meaning: a client machine will poll the Data Aggregation Service to ask for information it can use to go to a website and retrieve valuable information (such as a particular web page it should acquire). For example, if the request to be made is an HTTP request, the Data Acquisition Application polls the server and might receive a URL (an Internet address), header information, a method (“GET” or “POST”) and parameters. (Or the server pushes this information to the Data Acquisition Application over an open socket connection.) Upon receiving this information, the client-based Data Acquisition Application combines these elements into an HTTP request that it then transmits to the website. If the end user's preference profile resides on the client machine rather than the Data Aggregation Service, the Data Acquisition Application might instead receive the URL string except certain parameters that would be added based on the end user's preference profile.

“Client pull” occurs when a client machine contacts the Data Aggregation Service and downloads one or more specific or non-specific requests.

An “open socket connection” is a communication channel allowing two particular computers to transmit information.

“Server push” occurs when a client machine leaves a socket connection open, allowing the Data Aggregation Service to push specific or non-specific requests (such as HTTP requests) to the client-based Data Acquisition Application.

Modes of Operation

This invention has several distinct modes of operation.

For all modes, the data acquisition process entails the following steps:

1) The Data Acquisition Application is installed on the end user's client machine(s)

2) The end user stores their personal preference profile on the Data Aggregation Service and/or the client machine. [Please note that the end user may store their preference profile on the client machine and enable the Data Acquisition Application to transmit their preference profile, or relevant portions thereof, as needed, to the Data Aggregation Service (or permit the Data Aggregation Service to access that data directly on the client machine). We do not consider this to be a separate case since this is a specific example of the general case in which preference profile information is stored on both the client machine and the Data Aggregation Service, albeit only temporarily.]

3) Taking into account any relevant information from the end user's preference profile stored on the Data Aggregation Service, the Data Aggregation Application generates one or more specific or non-specific requests for the end user's Data Acquisition Application to acquire data. These requests may be generated and placed in a Client-Specific Request Queue (or generated and pushed to the client machine via an open socket connection) either immediately or after an intentional delay designed to disguise the automated nature of these requests by more closely simulating the actual behavior of human “websurfing.” Artificial delays between multiple requests sent by the same end user to the same website may make it harder for 3rd Party Websites to determine that the end user is utilizing an automated data acquisition program. Artificial delays may be produced by interspersing requests made to various 3rd Party Websites by the same client machine or by delaying the issuance of individual requests or by other means.

4) If using the “client pull” method, the Data Acquisition Application polls the server and receives requests in response.

5) If using the “server push” method, the server pushes requests to the client machine via an open socket connection.

6) If the request sent from the Data Aggregation Service to the Data Acquisition Application is a non-specific request, the Data Acquisition Application combines that non-specific request with relevant information from the end user's preference profile stored on the client machine. Since the end user will have stored their preference profile on the client machine, the Data Aggregation Service need merely send information sufficient for combining with preference profile information, residing on the client machine, to generate 3rd Party Website requests specific to that end user for issuance by that end user's client's Data Acquisition Application.

7) The Data Acquisition Application generates and transmits these requests to websites, perhaps after a delay designed to mimic human behavior and/or after the end user and/or the client computer logs into the 3rd party website.

8) The Data Acquisition Application receives responses to its requests

The various modes differ in what happens after the Data Acquisition Application receives responses.

Mode 1: Data Acquisition Simplification (“S2P2S2P”)

“Data acquisition simplification” is the simplification of the end user's task of acquiring desired data. Simplification may be achieved by various methods including, for example: 1) reducing the time required to locate, search through, download, aggregate, manipulate personalize and interpret data from various data sources, and, 2) reducing the manual work required to acquire data from various data sources.

Data acquisition simplification may, but need not, be enhanced by a related end user application that helps the end user use the acquired data. By definition of data acquisition simplification, any such end user application would reside on the client machine.

Data acquisition simplification is achieved as follows. After receiving a response from a 3rd Party Website, the Data Acquisition Application uses any data acquired for the benefit of the end user but does not return any of that data to the server. The data may or may not be manipulated by the Data Acquisition Application before being displayed or further manipulated on the client by the end user.

Mode 2: Data Acquisition Simplification and Incidental Retransmission

Mode 2 is like mode 1 except that it includes “incidental transmission” by which data acquired by the client is re-transmitted by the client to the server. By definition of mode 2, the end user receives no obvious benefit from sending data to the server but may nevertheless accept this arrangement in exchange for substantial time and effort savings due to data acquisition simplification and, possibly, the end user application.

Data acquired by the Data Acquisition Application is used by the end user and also returned to the server, but the data received by the server is not returned (after server-side refinement and processing) by the server to the client or end user. It is, however, available to the owner of the server for other purposes.

Mode 3: Data Aggregation with Server-side Processing and Personalization

Data acquired by the Data Acquisition Application may or may not be used by the end user but is always returned to the server. Once received by the server, the data may be refined and/or processed by the server, may be aggregated with other data (perhaps including data acquired by other Data Acquisition Applications), and the resulting enlarged database may be personalized for the end user before the server returns data to the client and/or end user.

Mode 4: Hybrid

The three modes mentioned above are not mutually exclusive. Hybrids of the above three modes are also useful, especially when having the client re-transmit all responses to the server is infeasible (perhaps due to bandwidth limitations), undesirable (perhaps because of the burden it would place on the server), or illegal (perhaps because the end user is allowed to view the information but is enjoined by the website's registration process terms of use agreement from retransmitting that data).

Certain data not returned to the server may still be available to the end user application (perhaps because it is stored on the client machine or because a reference or link to that information can be used by the client to later acquire the data for the end user's usage) while other data is re-transmitted to the server and may be aggregated with other data and/or personalized before being returned to the end user where it may then be combined with data not returned to the server.

Server-side Processing

The various modes described above differ in the degree to which the server receives, aggregates, processes and/or personalizes data from Data Acquisition Applications.

Server-side processing also determines which requests the server passes to each Data Acquisition Application. Many approaches could be used to program the server-side processing associated with the most fundamental invention described in this patent application (i.e., a method for acquiring data using a server connected to a distributed network of Data Acquisition Applications). Any such server-side program would have the following features: 1) it would track which data is stored on the server and/or client machines; 2) it would have access, on the server and/or the client machines, to preference profiles associated with individual end users; and, 3) it would know enough about websites to generate requests that will return valuable new information relevant and appropriate to each end user's preference profile; and, 4) it would send to Data Acquisition Applications requests that are relevant to the client machine's end user's preference profile.

Requests Generated Separately for Each User

One specific embodiment of server-side processing that is easy to implement but less than fully efficient (because it doesn't reduce the total number of requests sent to websites as much as it could) when the number of users with partially overlapping preference profiles is large is to generate requests separately for each end user. This reduces the load on 3rd Party Website servers:

Because data scraped from a 3rd Party Website can be stored on the Data Aggregation Service and served to end users from the Data Aggregation Service, no user needs to go back to the 3rd Party Websites each time they wish to view the data. Once the data has been acquired from the 3rd Party Website, it may be viewed as many times as desired without placing any further load on the 3rd Party Website.

Requests Generated in Coordinated Manner to Avoid Issuing Multiple Requests When User Preferences Overlap

A potentially more efficient embodiment of this invention is to reduce the overall load on scraped websites in the above-mentioned way and in another way:

Because many end user preference profiles partially or completely overlap, different end users will wish to view the same data. To the extent that multiple users desire to see the same data, fewer requests must be issued per end user. Only one request must be issued per piece of data (for however long that data is deemed “fresh enough”), regardless of how many end users desire to view that piece of data.

By utilizing information concerning partially overlapping end user preference profiles, the Data Aggregation Service can reduce the total number of requests made to 3rd party websites to acquire desired data. This second embodiment of server-side processing is substantially more efficient when the number of end users with partially overlapping preferences is large. This second embodiment is, therefore, guaranteed to greatly reduce the burden placed on 3rd Party Websites, especially when many end users have overlapping preference profiles.

Specifically, whenever preference profiles of two or more users overlap partially or fully, the task of acquiring data relevant to the overlapping portion of the preference profiles from one or more websites can be spread among the users. If, for example, ten end users are all searching for four-bedroom homes between $500,000 and $600,000 in Redmond, Wash., then the burden of scraping each website can be divided among the ten users. Total requests sent to each website can be reduced by a factor of 10.

An additional benefit of this method is that the total load can be divided among the users with overlapping profiles. Consequently, on average, each end user must visit only a fraction of the webpages they would need to visit to acquire all the information on their own. And the data can be acquired more quickly because the searches can be conducted simultaneously by all users. Because we can divide the total load among multiple users, users with slow, unreliable, episodic Internet access (such as a slow modem connection) can get access to data acquired by users without “always-on broadband” connections. Another advantage is that the centralized data collector knows all the websites where useful information can be acquired.

Yet another benefit is that there is a substantial one-time “fixed cost” to identifying relevant online information sources (e.g., Internet websites), determining how each information source presents its data, how to best acquire (“scrape”) such data from any information source, and monitoring for changes in the way each information source presents its data (necessitating a change in how data should be acquired from the information source). By spreading the fixed cost across many users, the average cost is much lower, so a centralized Data Aggregation Service can provide data to users at lower average cost. In practice, this benefit might be realized by each end user paying a small fee to a Data Aggregation Service that researches information sources and creates a system that aggregates data for the end user and many other users. Each end user would be spared the time and aggravation of searching for useful information sources and processing information that is presented in many different formats by various information sources.

For explanatory purposes, we describe this embodiment using a three-dimensional example (using price, city/town and number of bedrooms as the three dimensions), but real-world embodiments may use an N-dimensional preference profile where N is a large number.

Consider the following imaginary search profiles. Mary is searching for a 3- or 4-bedroom home between $500,000 and $700,000 in Palo Alto, Calif. or Menlo Park, Calif. while Bruce is searching for a 4- or 5-bedroom home between $600,000 and $800,000 in Palo Alto, Calif. or Woodside, Calif.

Their preferences partially overlap: 4-bedroom homes in Palo Alto priced between $600,000 and $700,000.

| | | Min | Max | | |
|---|---|---|---|---|---|
| | | bed- | bed- | | |
| | Location(s) | rooms | rooms | Min price | Max price |
| Mary | Menlo Park or | 3 | 4 | $500,000 | $700,000 |
| | Palo Alto | | | | |
| Bruce | Palo Alto or | 4 | 5 | $600,000 | $800,000 |
| | Woodside | | | | |
| OVERLAP | Palo Alto | 4 | 4 | $600,000 | $700,000 |
| (Mary & | | | | | |
| Bruce) | | | | | |

This overlap may not appear very significant, but as the number of end user profiles increases, the potential for overlap is far greater because the number of possible overlapping profiles grows at the rate of N(N-1)/2, where N is the number of preference profiles. The first ten values of N(N-1)/2 are 0, 1, 3, 6, 10, 15, 21, 28, 36, 45. With one user, there is no possible overlap. With two users, as in the table above, there is the possibility that they may overlap.

With three users, there are three possible overlaps. If Janet signs up and searches for a home in Menlo Park or Woodside with 3-to-5-bedrooms priced between $500,00 and $800,000, then her profile will overlap with both Mary and Bruce's profiles:

| | | Min | Max | | |
|---|---|---|---|---|---|
| | | bed- | bed- | | |
| | Location(s) | rooms | rooms | Min price | Max price |
| Mary | Menlo Park or | 3 | 4 | $500,000 | $700,000 |
| | Palo Alto | | | | |
| Bruce | Palo Alto or | 4 | 5 | $600,000 | $800,000 |
| | Woodside | | | | |
| Janet | Menlo Park or | 3 | 5 | $500,000 | $800,000 |
| | Woodside | | | | |
| OVERLAP | Palo Alto | 4 | 4 | $600,000 | $700,000 |
| (Mary & | | | | | |
| Bruce) | | | | | |
| OVERLAP | Menlo Park | 3 | 4 | $500,000 | $700,000 |
| (Mary & | | | | | |
| Janet) | | | | | |
| OVERLAP | Woodside | 4 | 5 | $600,000 | $800,000 |
| (Bruce & | | | | | |
| Janet) | | | | | |

If we add a fourth user, there would be six possible overlaps.

When profiles overlap, an opportunity exists to further reduce the number of requests per end user that must be issued to acquire data from a website.

### DETAILED DESCRIPTION OF THE FIGURES AND THE PREFERRED EMBODIMENT

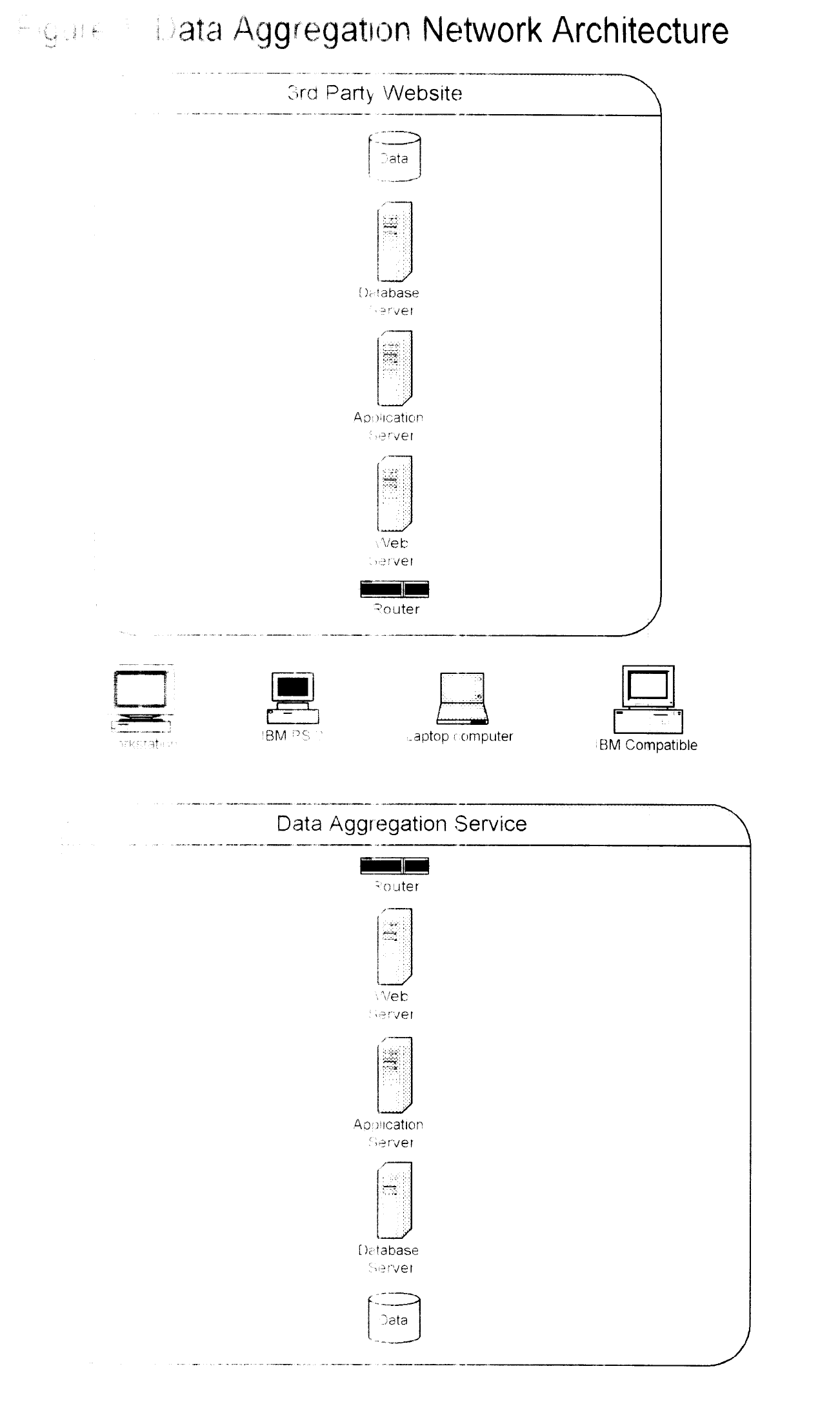

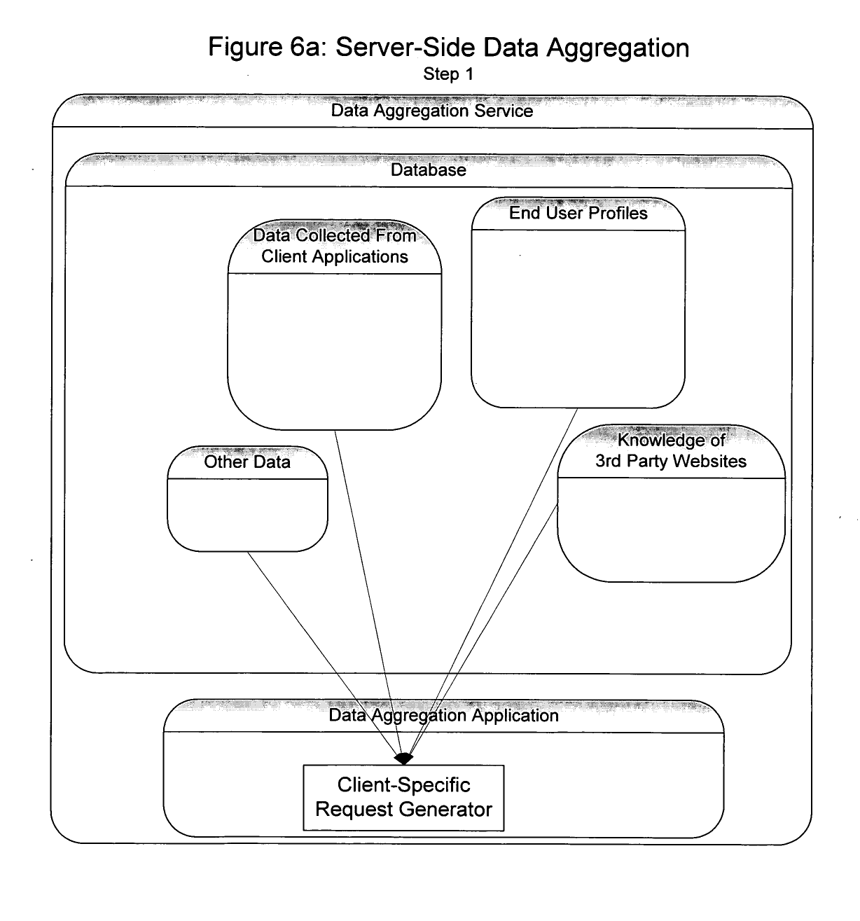

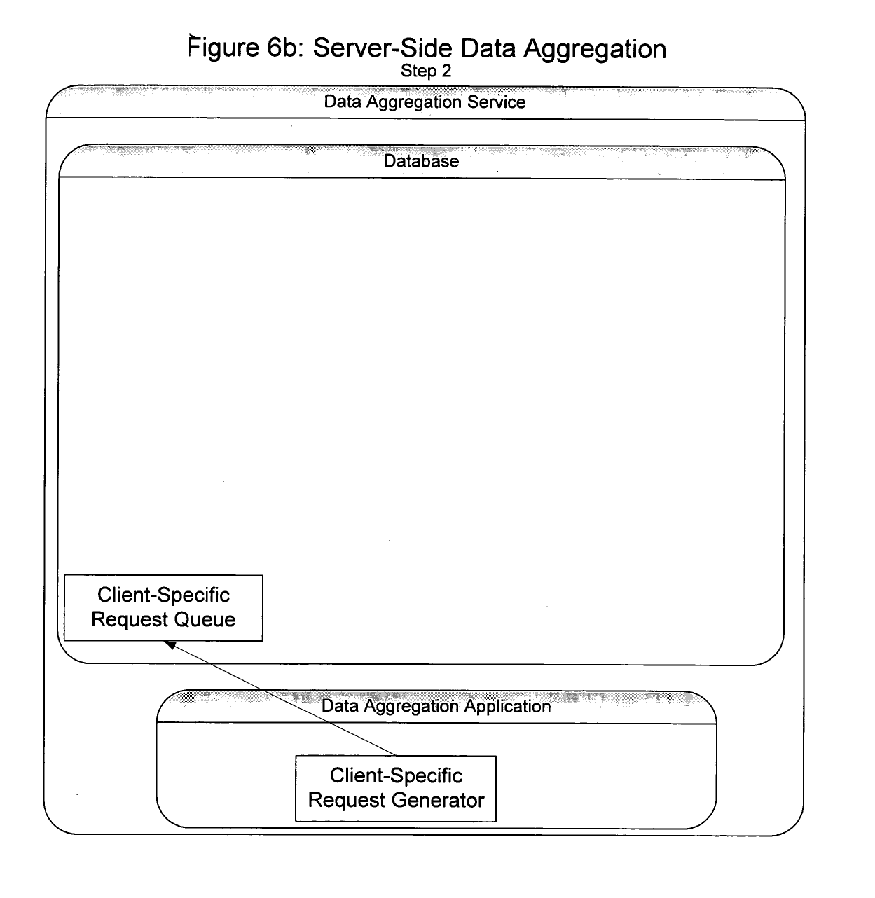

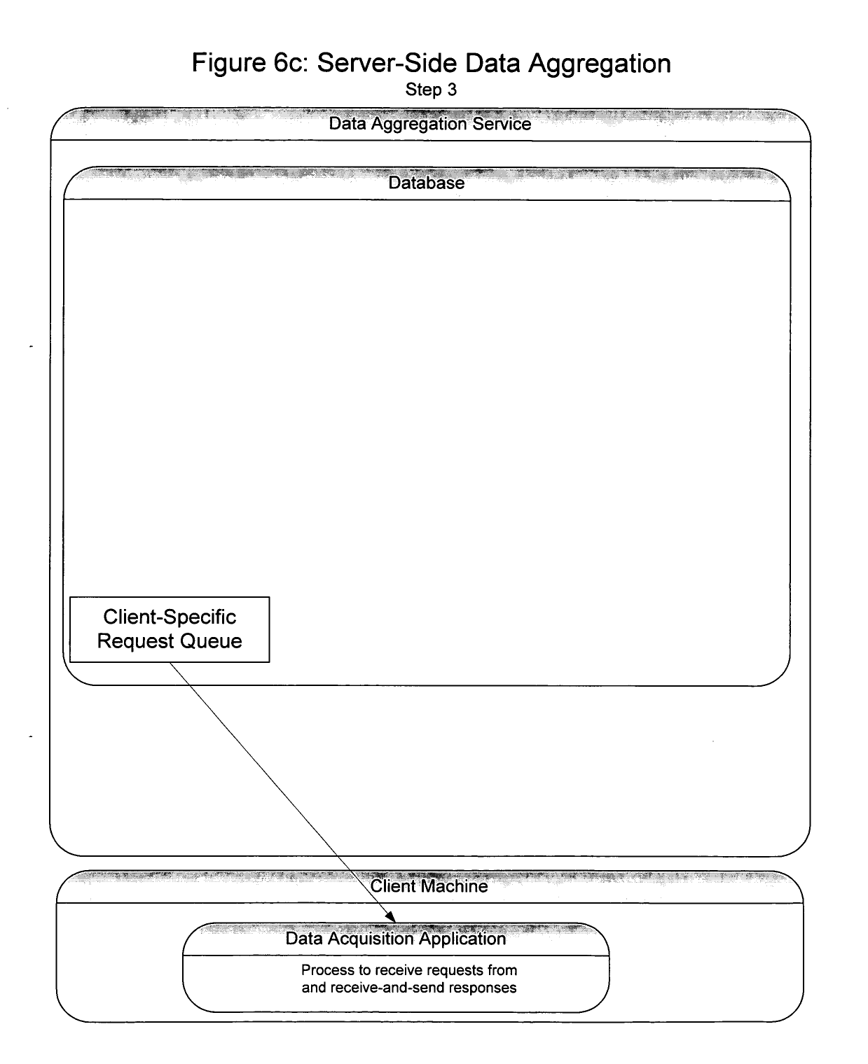

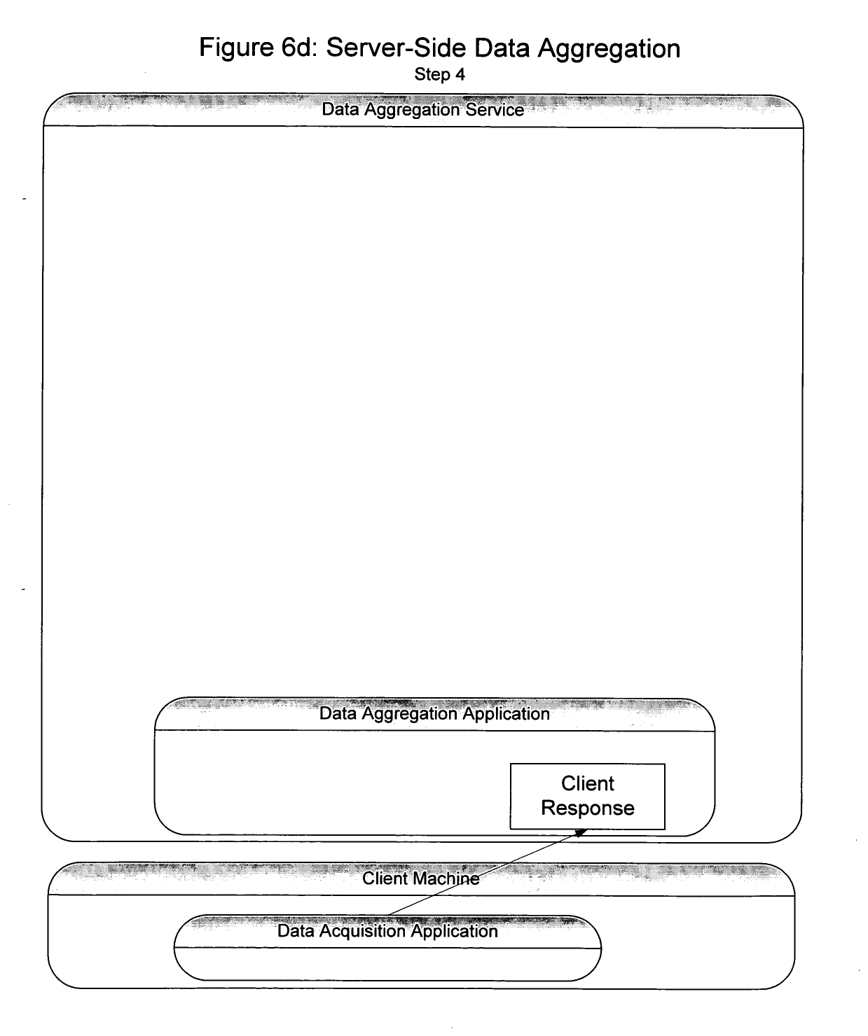

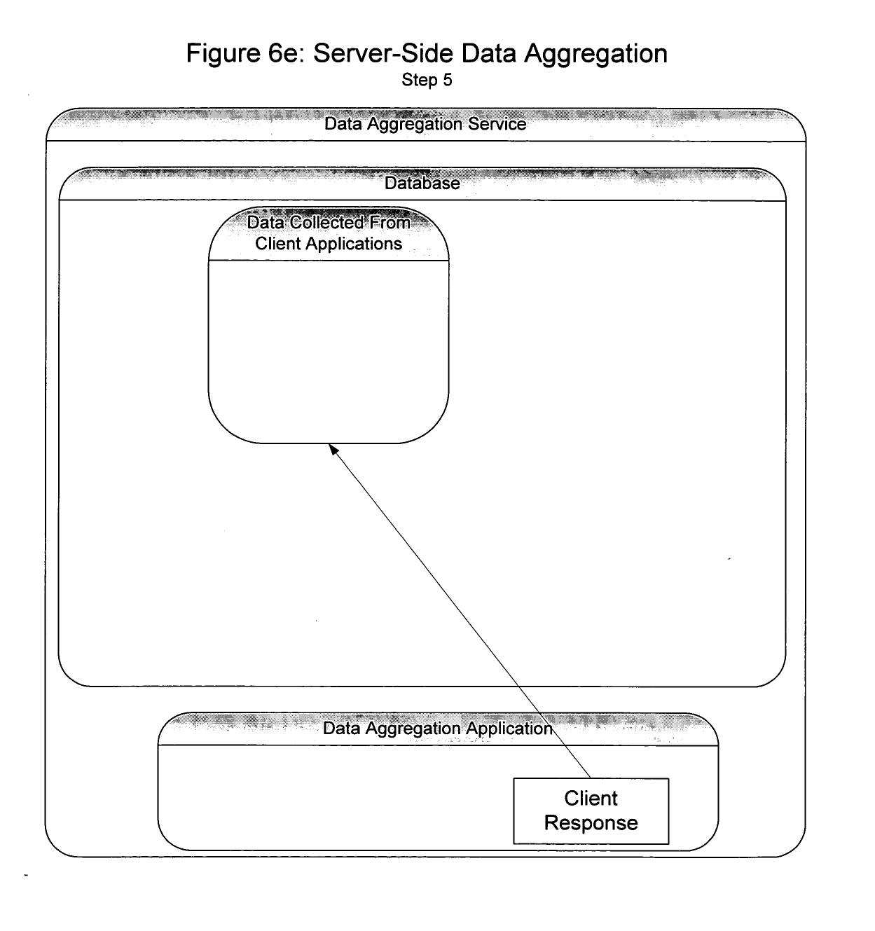

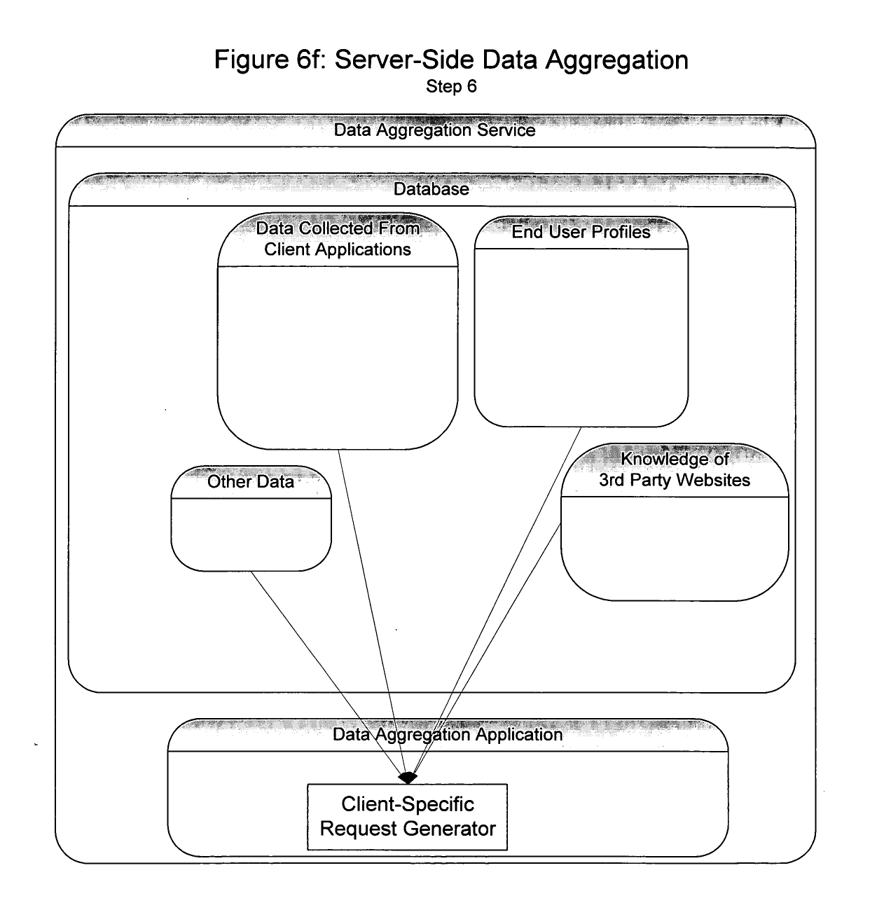

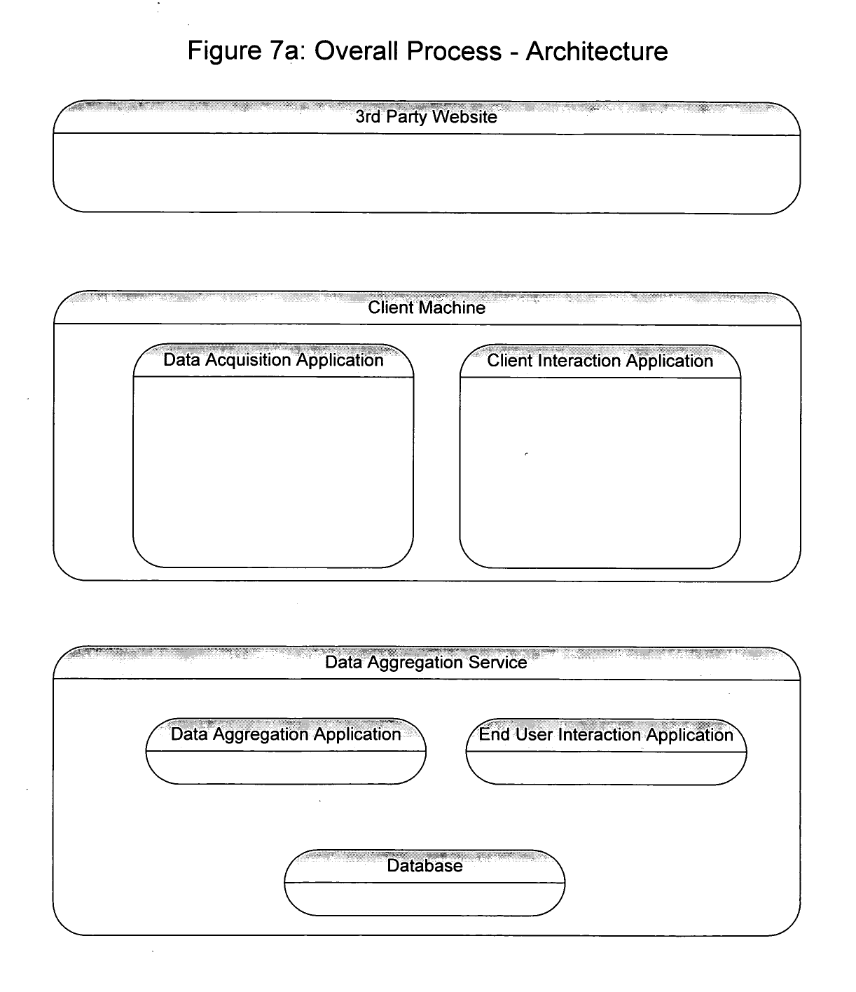

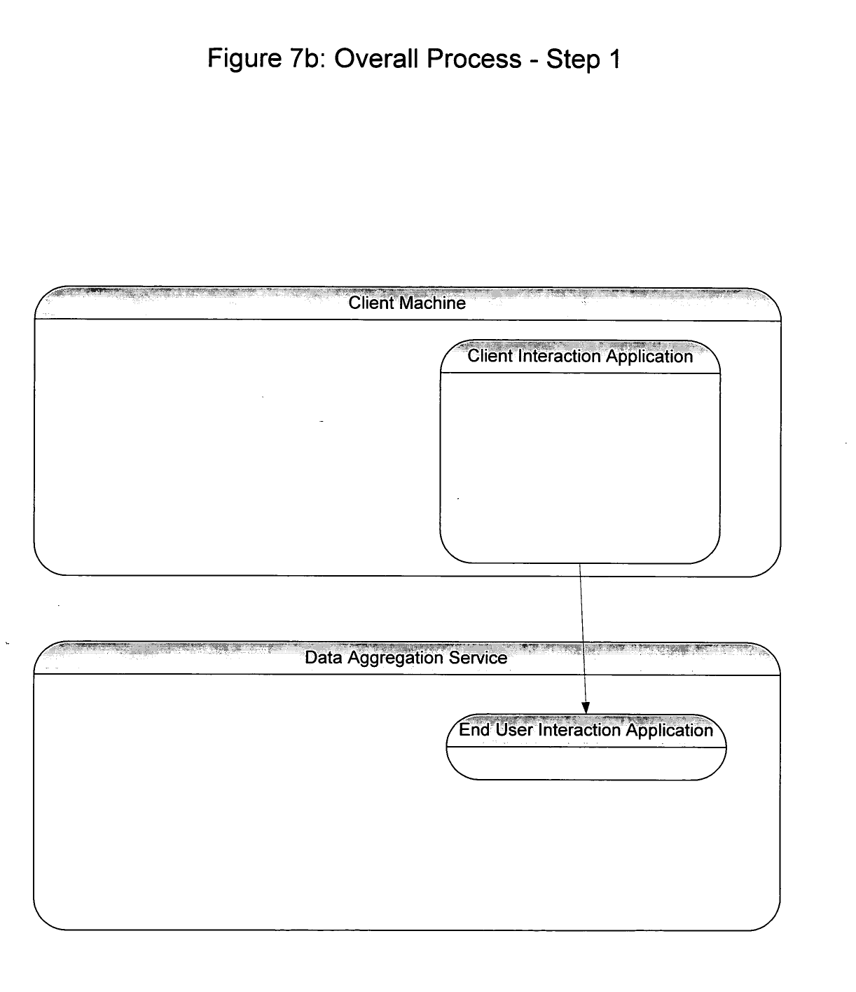

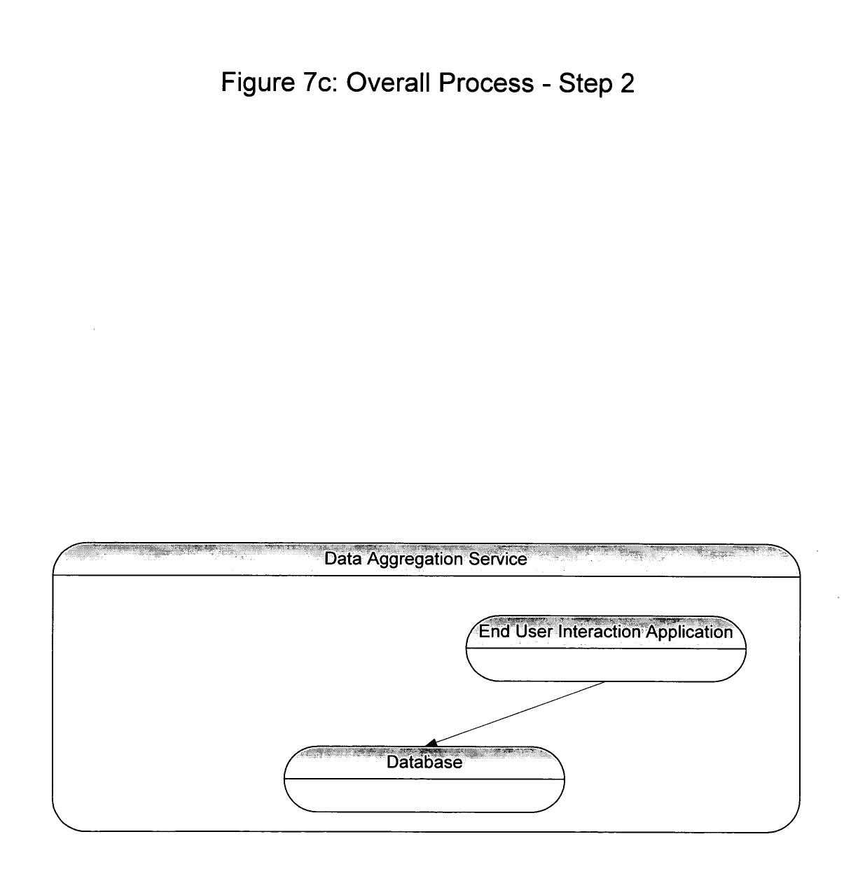

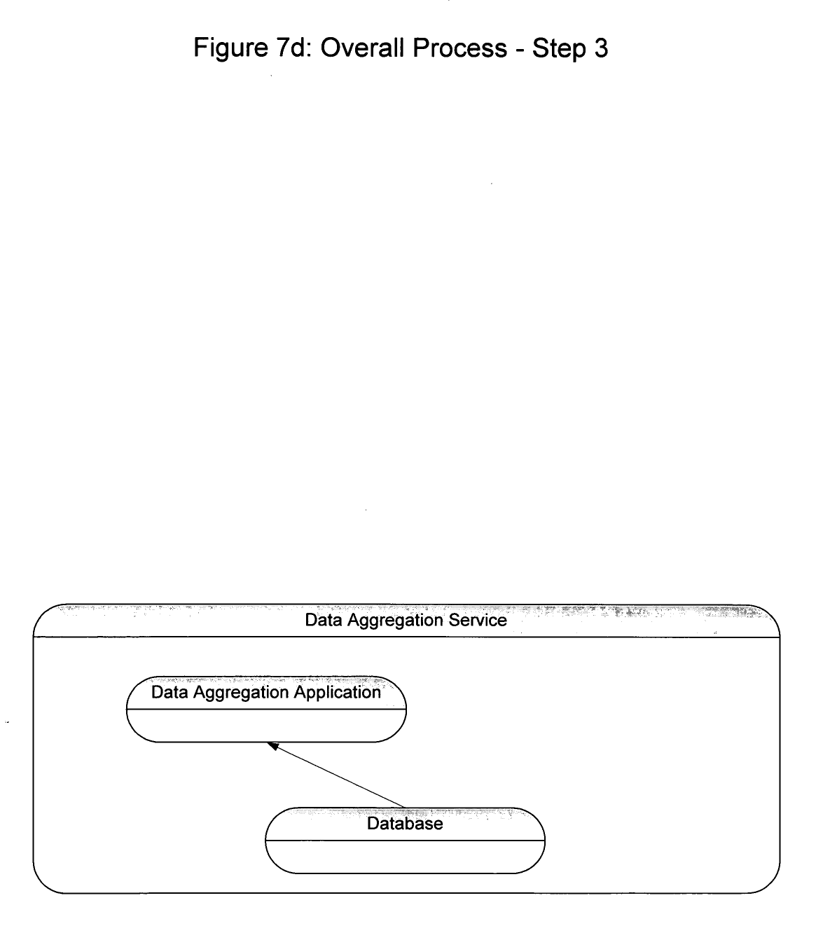

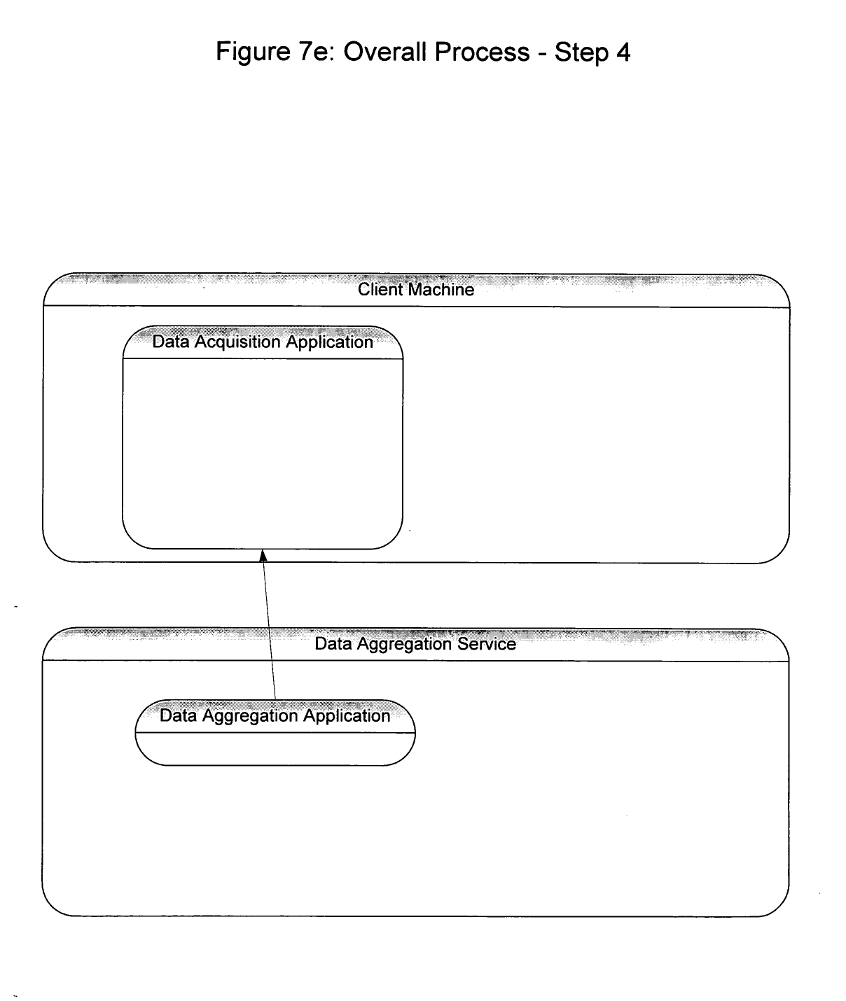

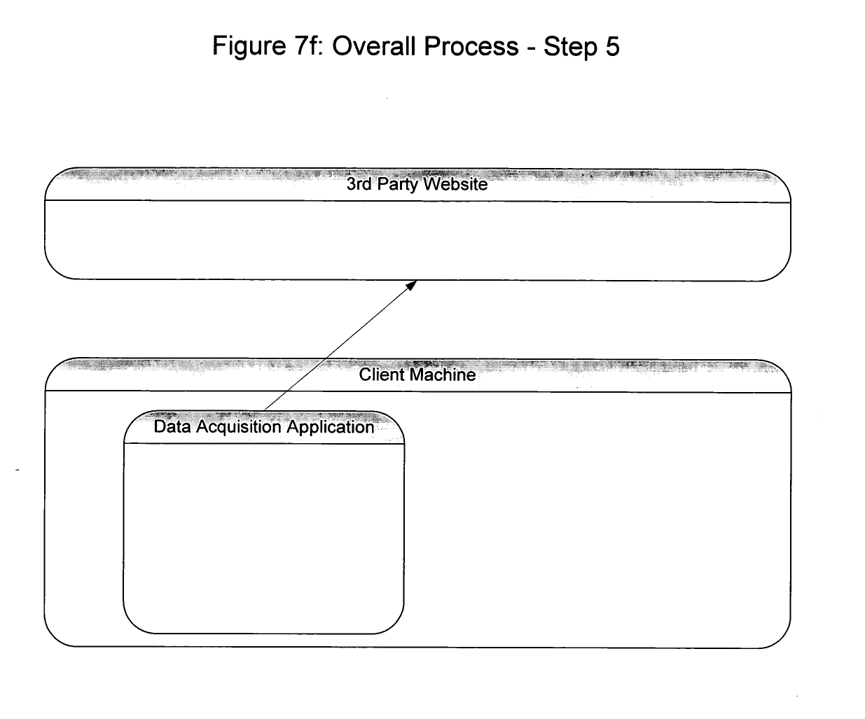

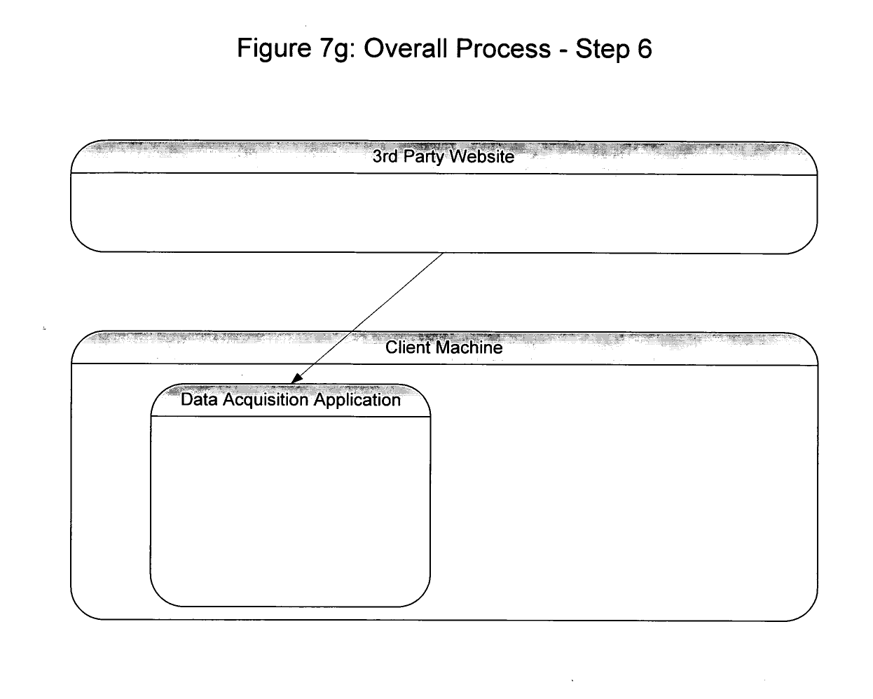

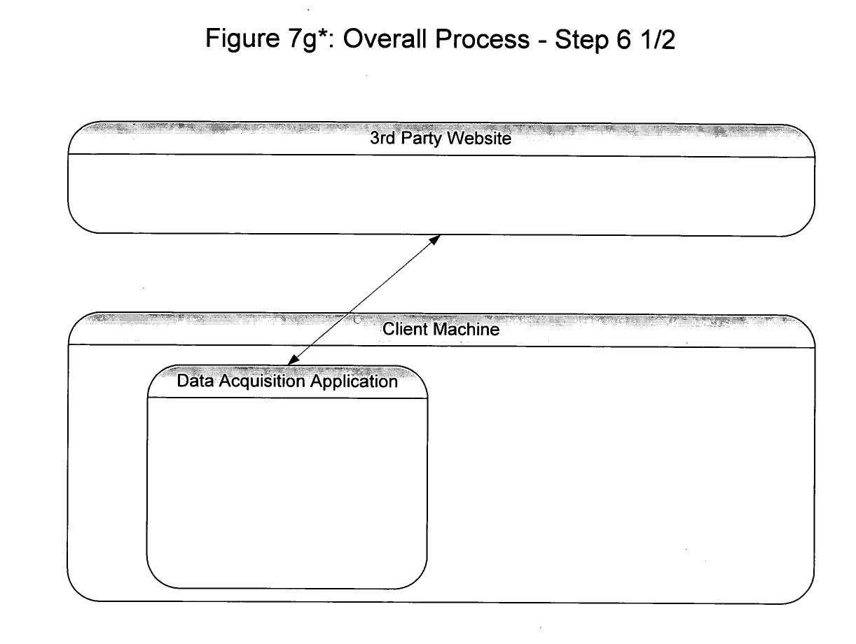

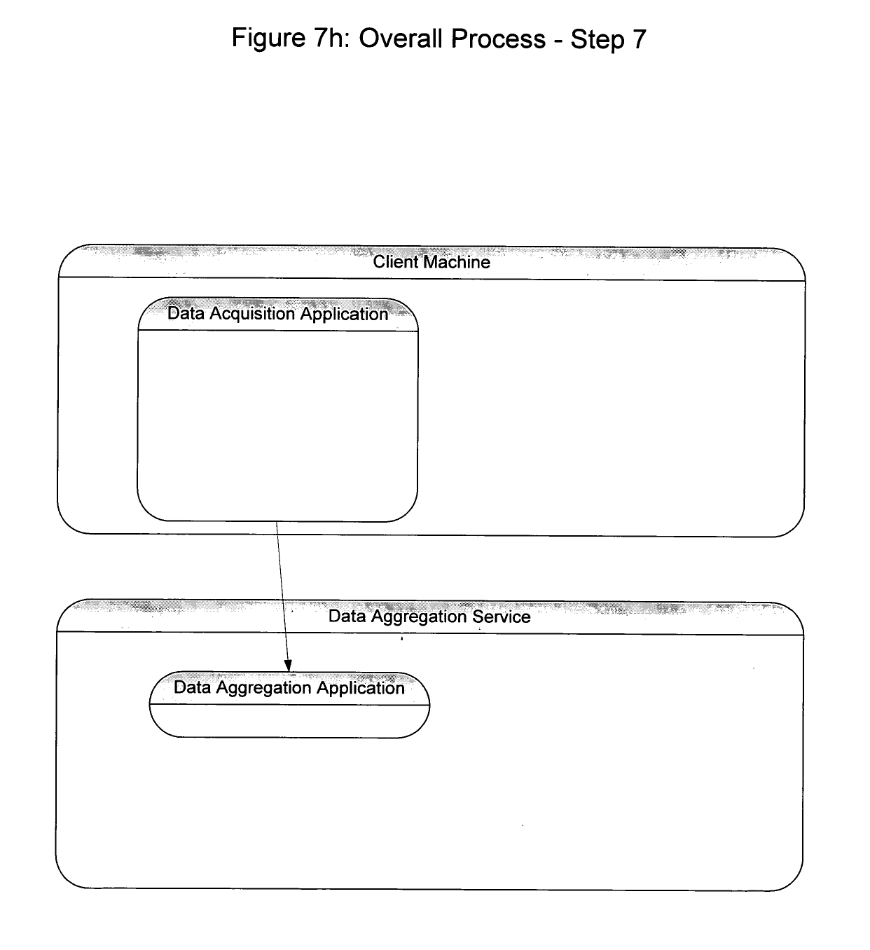

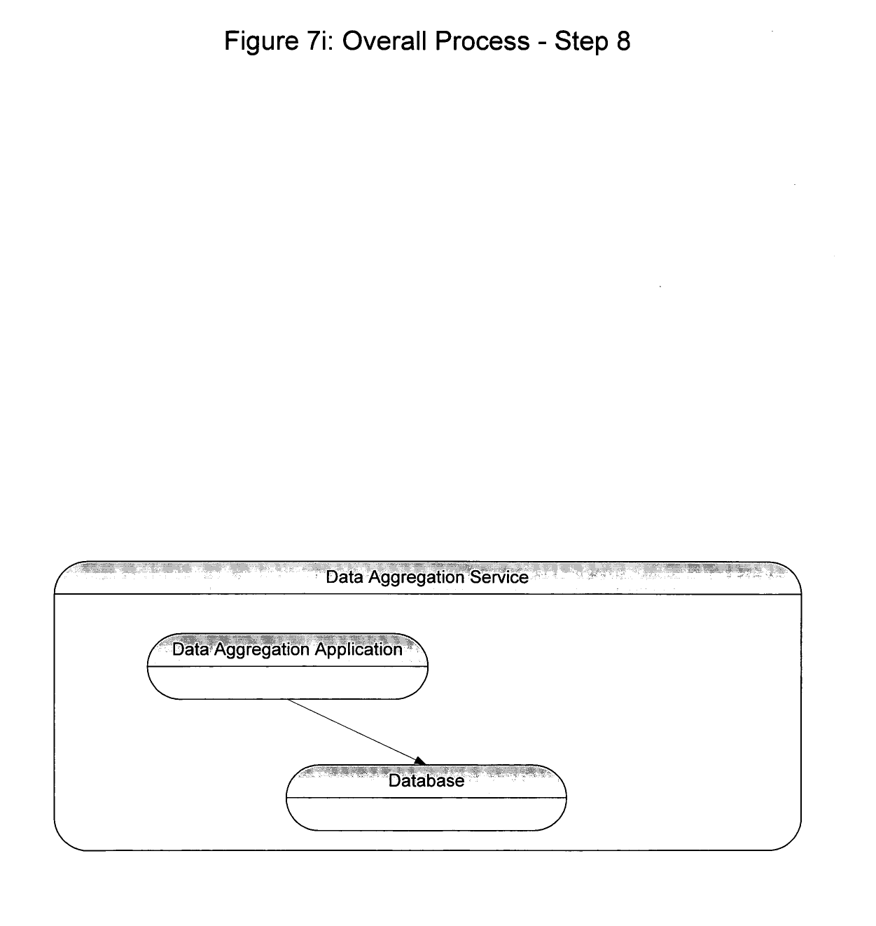

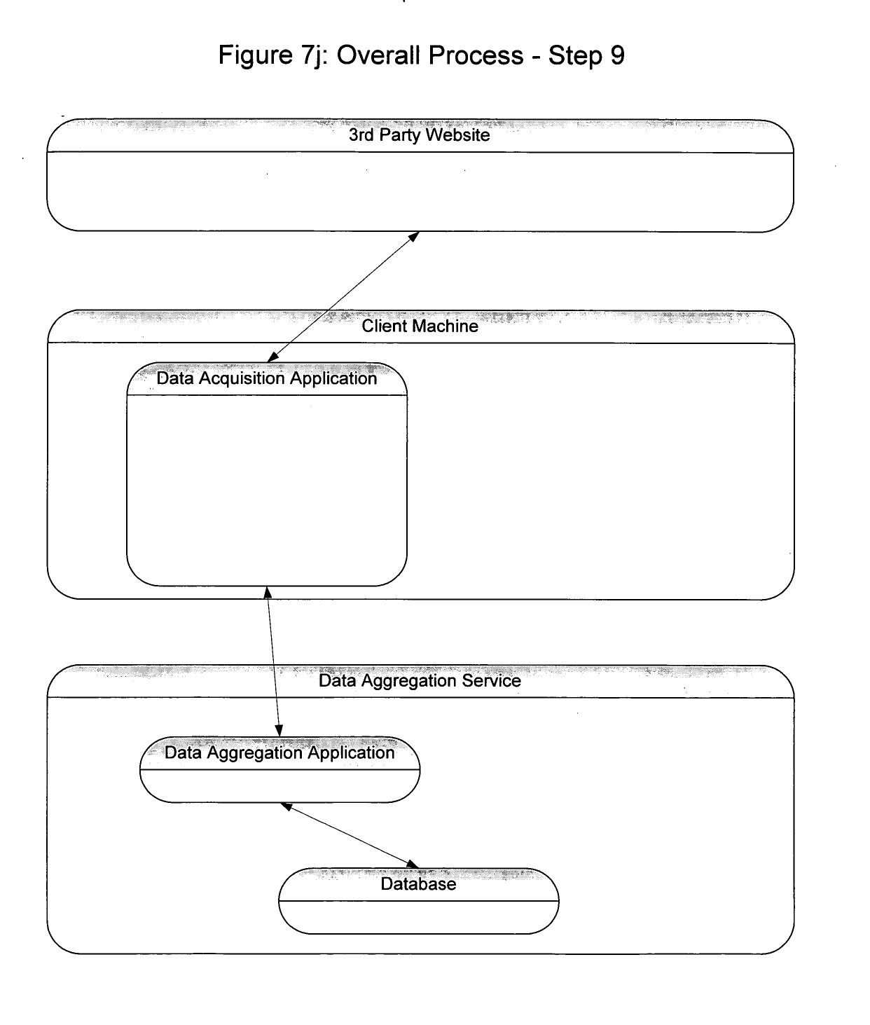

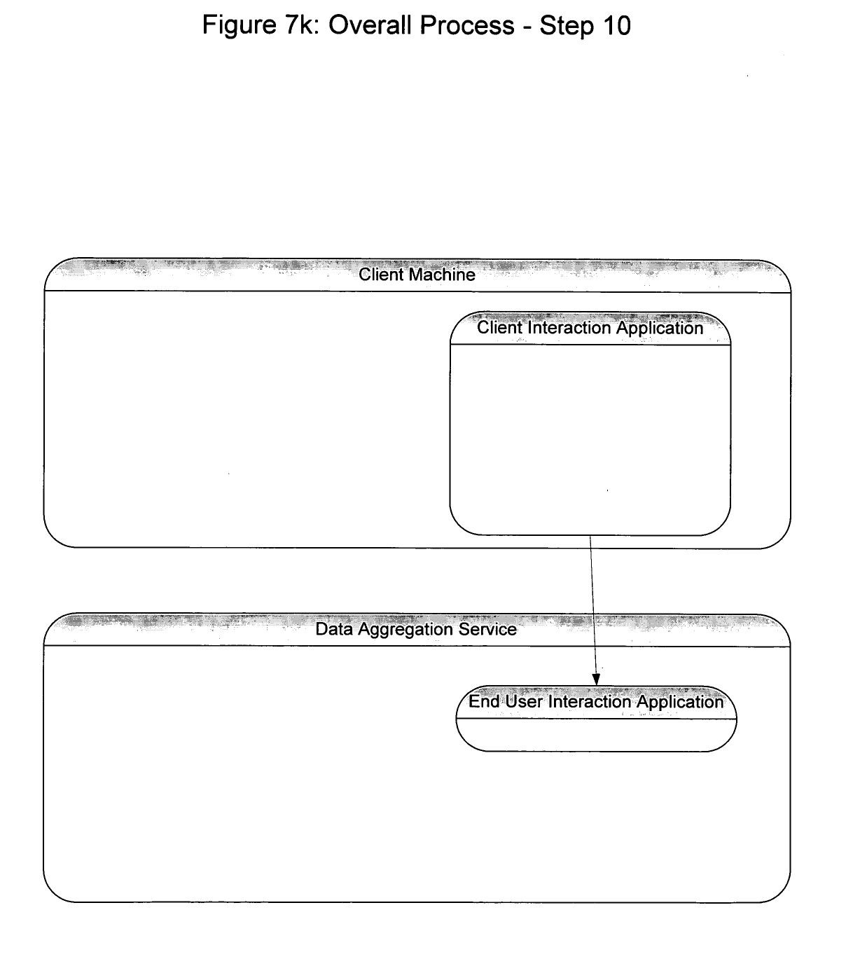

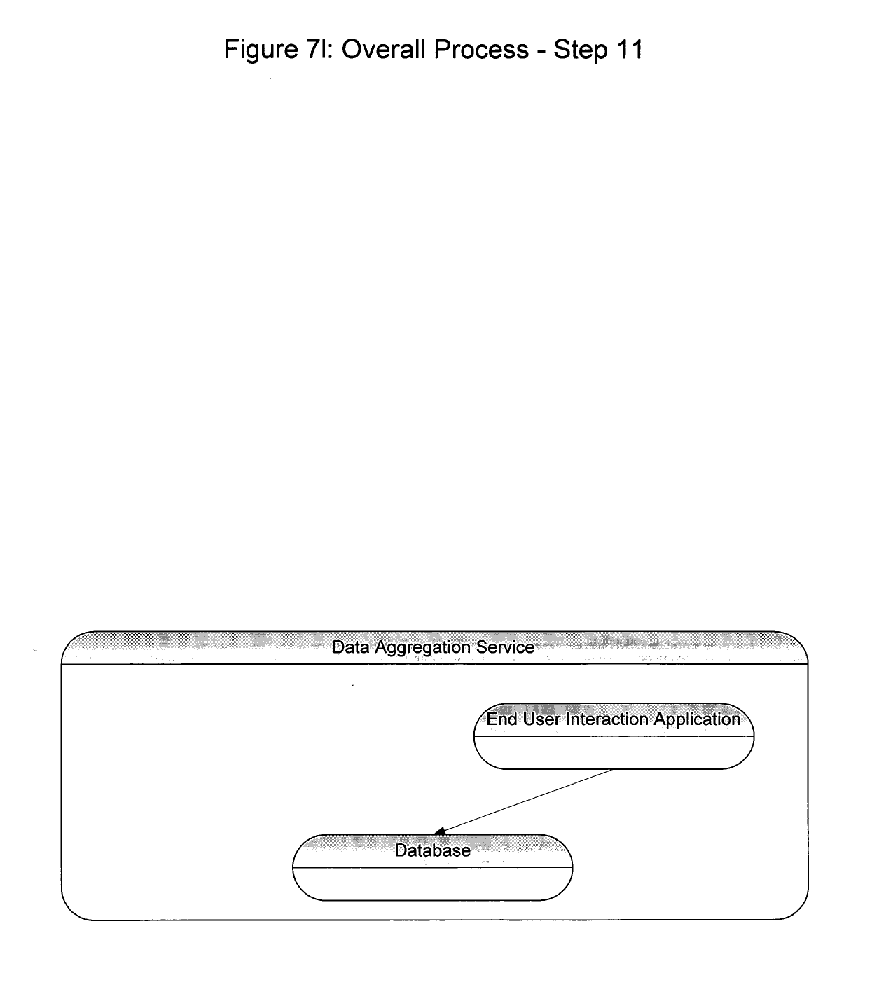

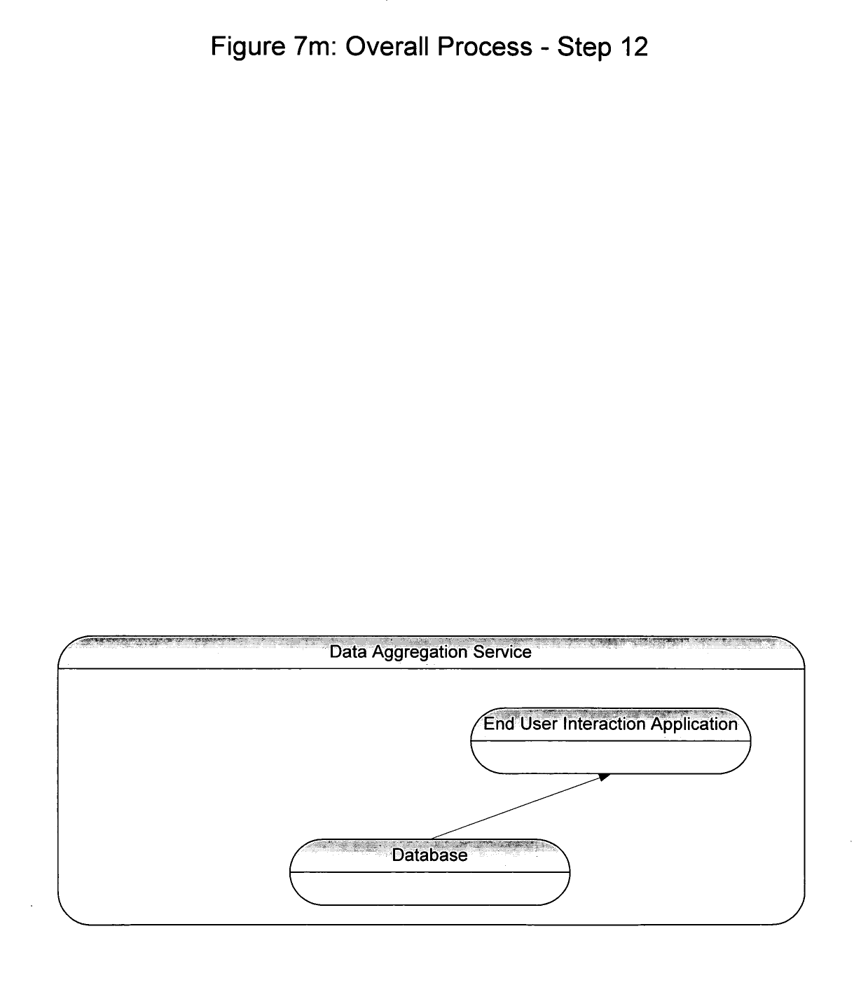

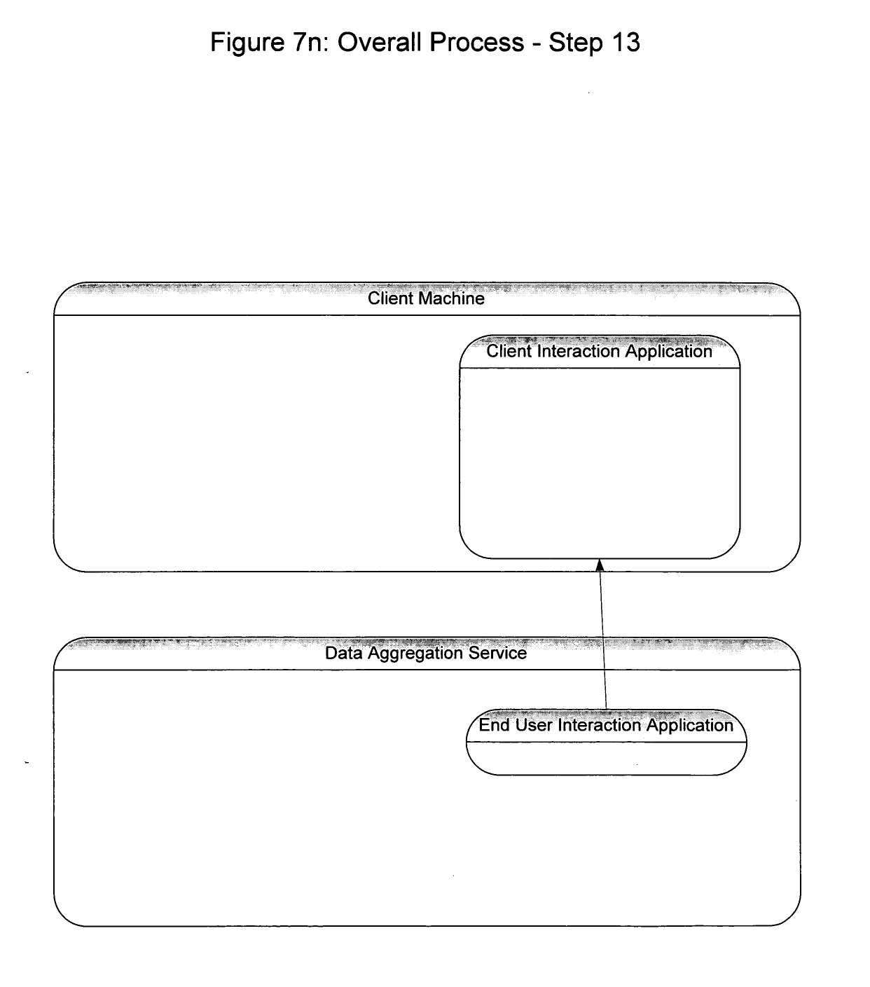

FIG. 1 lays out a typical network hardware architecture over which the processes described in this invention occur. Applications and data described in FIGS. 6 and 7 reside on hardware devices similar to those depicted in FIG. 1.

The “3rd Party Website” may consist of a router (possibly with a firewall) connected to a web server connected to an application server connected to a database server connected to data that is possibly stored on hard drives or a disk array.

Likewise, the “Data Aggregation Service” may be structured similarly with a web server connected to an application server connected to a database server connected to data that is possibly stored on hard drives or a disk array.

Client machines (such as the “Workstation,” “IBM PS/2,” “Laptop computer” and “IBM Compatible” depicted in the diagram) connect to both the “3rd Party Website and the “Data Aggregation Service” via the Internet (or similar method for connecting computers).

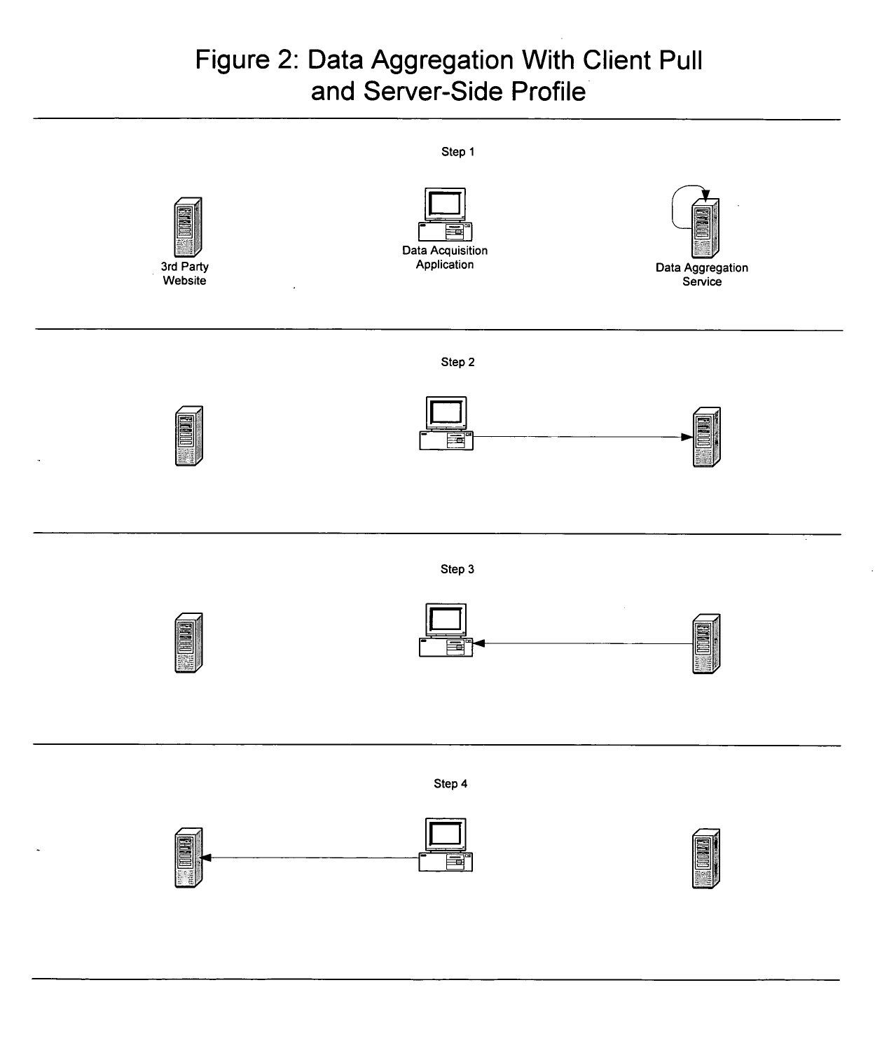

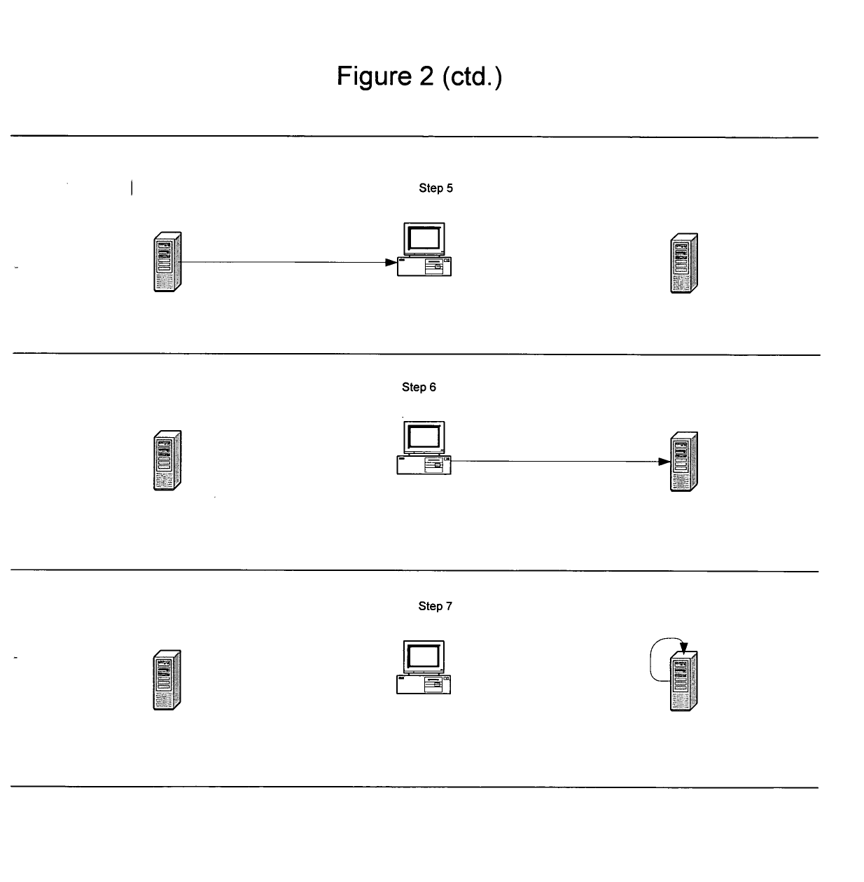

In FIGS. 2, 3, 4 and 5, we collapse everything contained within the “3rd Party Website” box of FIG. 1 into a single “3rd Party Website” icon representing everything in the upper half of FIG. 1. We also collapse everything contained within the “Data Aggregation Service” box of FIG. 1 into a single “Data Aggregation Service” icon representing everything in the lower box of FIG. 1.

FIG. 2 lays out the step-by-step process by which the Data Acquisition Application acquires data from a 3rd Party Website when the end user's preference profile is stored on the Data Aggregation Service and when the Data Acquisition Application pulls specific requests from the Client-Specific Request Queue on the Data Aggregation Service.

FIG. 2, Step 1: The Data Aggregation Service generates a request for the Data Acquisition Application to scrape. This request is then placed in the Client-Specific Request Queue. A request placed in the Client-Specific Request Queue may be tagged for pick-up by only a particular client, any of an enumerated list of clients whose users share certain search profile information, or any client whose user has a particular type of preference profile. The request generation process may take into account information the Data Aggregation Service possesses regarding the user's preferences, preferences of any other users with partially overlapping preferences, the data the Data Aggregation Service already possesses, which queries of which information sources the Data Aggregation Service has generated and/or for which it has received responses, how recently the aforementioned queries were generated and/or responses were returned, etc. For example, an application that acquires residential real estate information might keep track of how recently a particular home profile (such as 4 bedroom homes in Wayland, Mass. priced between $500,000 and $600,000) had been “partially scraped” and “completely scraped” from a particular website where “partial scraping” might look only at home lists to see which homes appear in search results and whether the listing prices have changed (and perhaps look at detailed information pages of homes found for the first time on that website) whereas “complete scraping” would take the further step of going to each house's detailed information page to see whether any facts about the home had been altered since the home's detail page was last visited. The Data Aggregation Service might perform “partial scraping” daily and “complete scraping” weekly.

FIG. 2, Step 2: The Data Acquisition Application frequently polls the Data Aggregation Service for a request to scrape. When a Data Acquisition Application is running, it frequently checks for requests, perhaps at regular intervals such as every 10 seconds or every minute and/or after it returns a response. If the server has generated no request for the Data Acquisition Application, the Data Acquisition Application waits a while before polling again. If a request has been tagged by the Data Aggregation Service for pick-up by any of an enumerated list of clients or by any client whose user's profile satisfies certain criteria, the request stored in the Client-Specific Request Queue will be picked up by the first matching client that polls the server (except, perhaps, if multiple requests match the client and the client downloads only a subset of the requests). When the Data Acquisition Application finds at least one matching request, the client will “check out” one or more requests. The number of requests “checked out” at any given time by any particular client may be adjusted to improve overall performance of the client and/or server system. If a request has been “checked out” for a significant period of time and the client machine that checked it out has not returned a response, the Data Aggregation Service may reassign the request to another matching client or clients.

In FIG. 2, the terms “Step 1” and “Step 2” are for the sake of exposition only. “Step 1” may happen after “Step 2” because the Data Aggregation Service and Data Acquisition Application are not coordinated in any manner. “Step 2” is a continuing process in which the Data Acquisition Application looks for requests generated by the Data Aggregation Service. The Data Aggregation Service places requests for the Data Acquisition Application in the Client-Specific Request Queue, and the Data Acquisition Application picks up requests from its Client-Specific Request Queue.

FIG. 2, Step 3: The Data Aggregation Service may delay generating or placing a generated request into the Client-Specific Request Queue in order to simulate a human being interacting with a 3rd Party Website (to prevent the website from detecting the automated data acquisition technology). Once one or more requests are placed into the Client-Specific Request Queue on the Data Aggregation Service for the Data Acquisition Application, the Data Acquisition Application downloads one or more requests.

FIG. 2, Step 4: The Data Acquisition Application sends one or more requests to one or more 3rd Party Websites. These requests may be issued immediately or after an intentional delay designed to simulate a human user so as to hide the automated nature of the data request. Also, these requests may be issued after the client machine logs into the 3rd party website (either by manual action by the end user or by computer-based retrieval of the end user's username, password, and/or any other necessary information from either the Data Acquisition Application or the Data Aggregation Service).

The Data Acquisition Application may also be intelligent enough to register the user (with the user's permission) on any site that requires registration by transmitting sufficient user information to the 3rd Party Website from the user information stored within either the Data Acquisition Application or the Data Aggregation Service.

The Data Acquisition Application may also iterate FIG. 2, Step 4 by generating one or more follow-up rounds of requests and sending them to one or more 3rd Party Websites. These follow-up rounds of requests may be based on information returned in responses to earlier-round requests. For example, a search request for homes for sale might return a response of a list of 10 homes, each with a hyperlink (electronic pointer) to another webpage with detailed information about that particular house, and a “Next” button to move to another page where the next 10 homes matching the initial search criteria can be found. The Data Acquisition Application might intelligently generate 11 follow-up requests, one request to generate the next list of 10 homes (as if a user had clicked the “Next” button) and one for detailed information about each of the 10 houses on the current list of 10 homes (as if a user had clicked on each of the links to details about each of the 10 homes). The simplest application of this “client-side intelligence” is “link crawling” in which the client is instructed to follow links to other webpages. Additional intelligence might be built into the client in Step 4 so that the client can act as a surrogate for the request-generation process within the Data Aggregation Service. For example, the Data Aggregation Service might pass to the Data Acquisition Application information about what data the Data Aggregation Service already possesses. The Data Acquisition Application might be programmed to return to the Data Aggregation Service only information that the Data Aggregation Service does not already possess. This could substantially reduce the total bandwidth required by the Data Aggregation Service and substantially reduce the load on the Data Aggregation Service's computers. Also, the program could be told to follow only some links or to request links out of order in order to disguise the automated nature of the requests.

FIG. 2, Step 5: The 3rd Party Website(s) send one or more responses back to the Data Acquisition Application.

FIG. 2, Step 6 (S2P2S2P2S only): The Data Acquisition Application returns one or more response(s) to the Data Aggregation Service. This step occurs in the S2P2S2P2S case but not in the S2P2S2P case.

FIG. 2, Step 7: The entire process repeats with the Data Acquisition Application continuing to poll the Data Aggregation Service for additional requests and send back responses to the Data Aggregation Service.

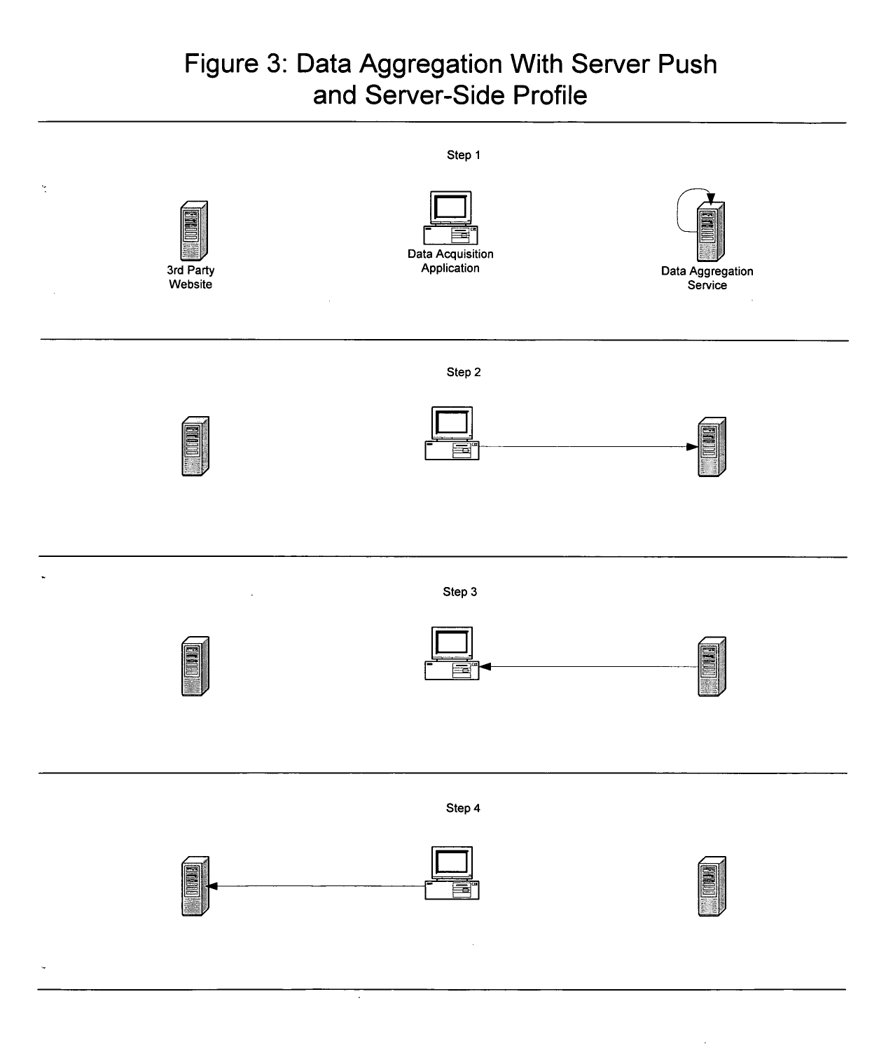

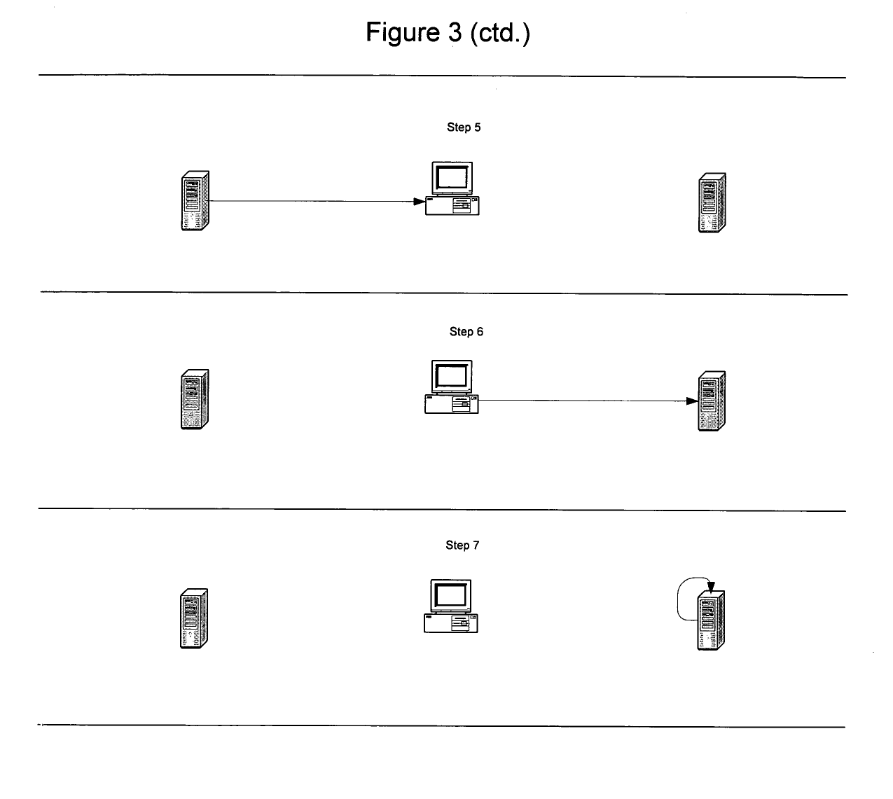

FIG. 3 is identical to FIG. 2 except for Steps 2 & 3 in which the Data Acquisition Application opens a socket connection to the Data Aggregation Service and the Data Aggregation Service pushes a request to the Data Acquisition Application. This is a “Server Push” method, rather than a “Client Pull” method because the Data Aggregation Service server pushes requests to the Data Acquisition Application rather than the Data Acquisition Application pulling the request from the Data Aggregation Service. Again, either the Data Aggregation Service or the Data Acquisition Application can create an artificial delay to more closely mimic human behavior.

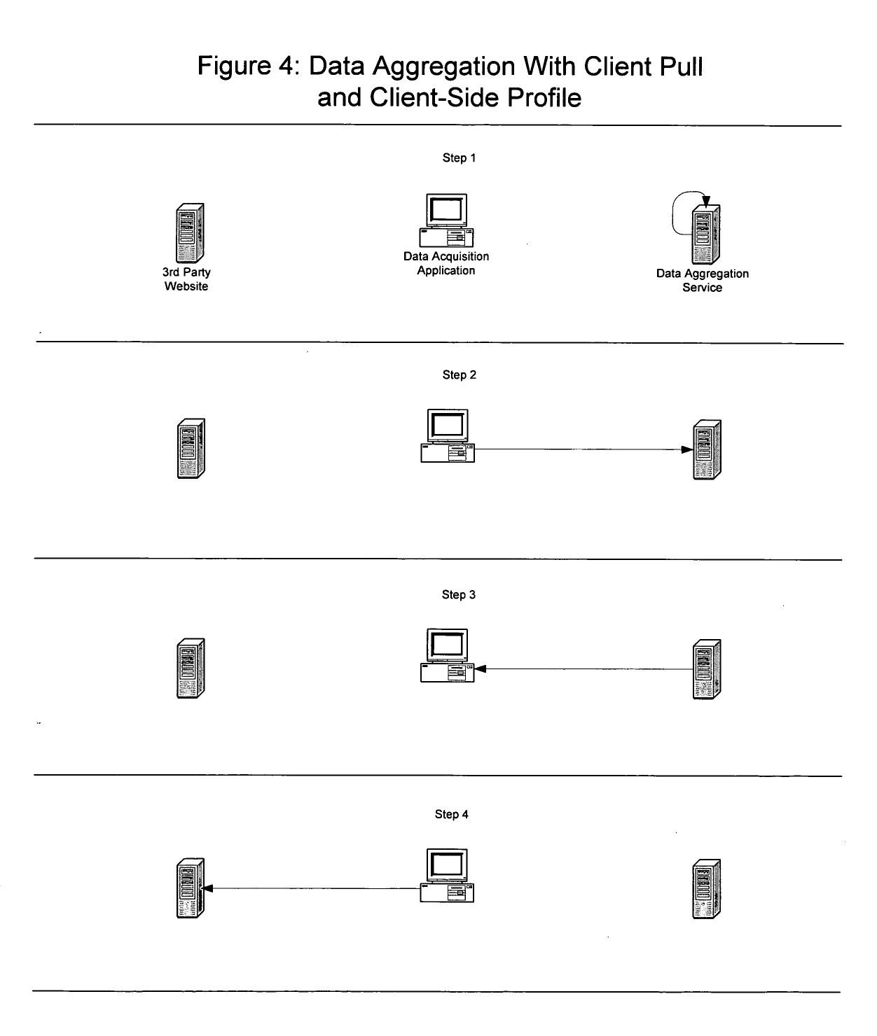

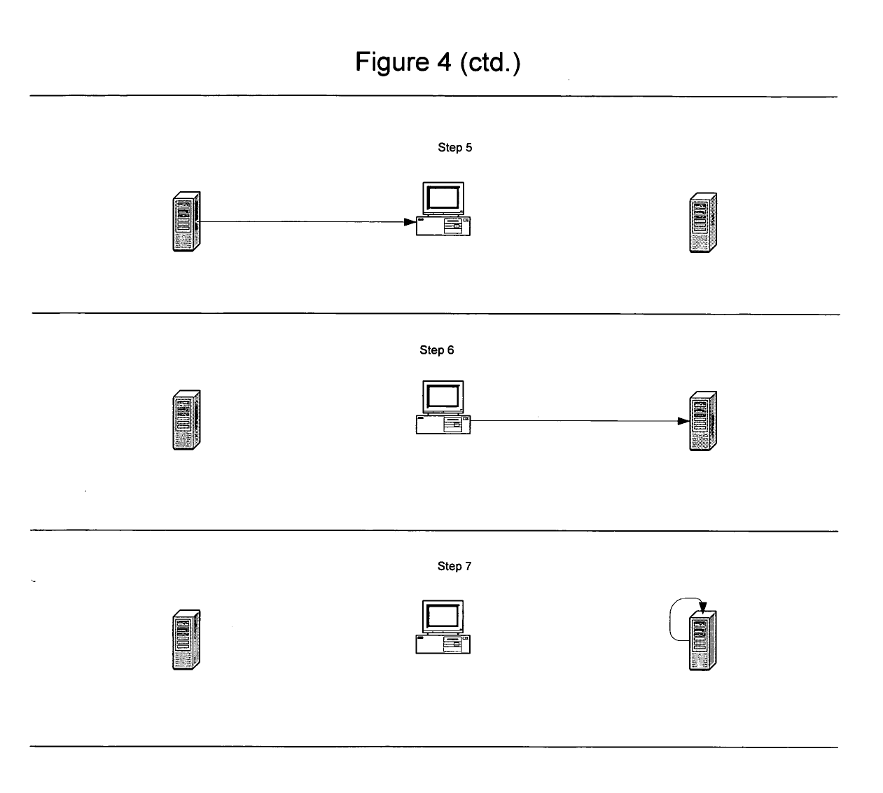

FIG. 4 is identical to FIG. 2 except that the end user profile resides on the client machine, not the Data Aggregation Service. For this reason, the Data Aggregation Service prepares a non-specific request for the Data Acquisition Application (in Step 1) that is then downloaded by the Data Acquisition Application (in Step 3). The Data Acquisition Application then combines the non-specific request with relevant preference profile information residing on the client machine to generate a specific request related to the end user's preference profile that it then sends to the 3rd Party Website (in Step 4), perhaps after a delay designed to simulate human interaction with the 3rd Party Website. As in FIG. 3, these requests may be issued after the client machine logs into the 3rd party website (either by manual action by the end user or by computer-based retrieval of the end user's username, password, and/or any other necessary information).

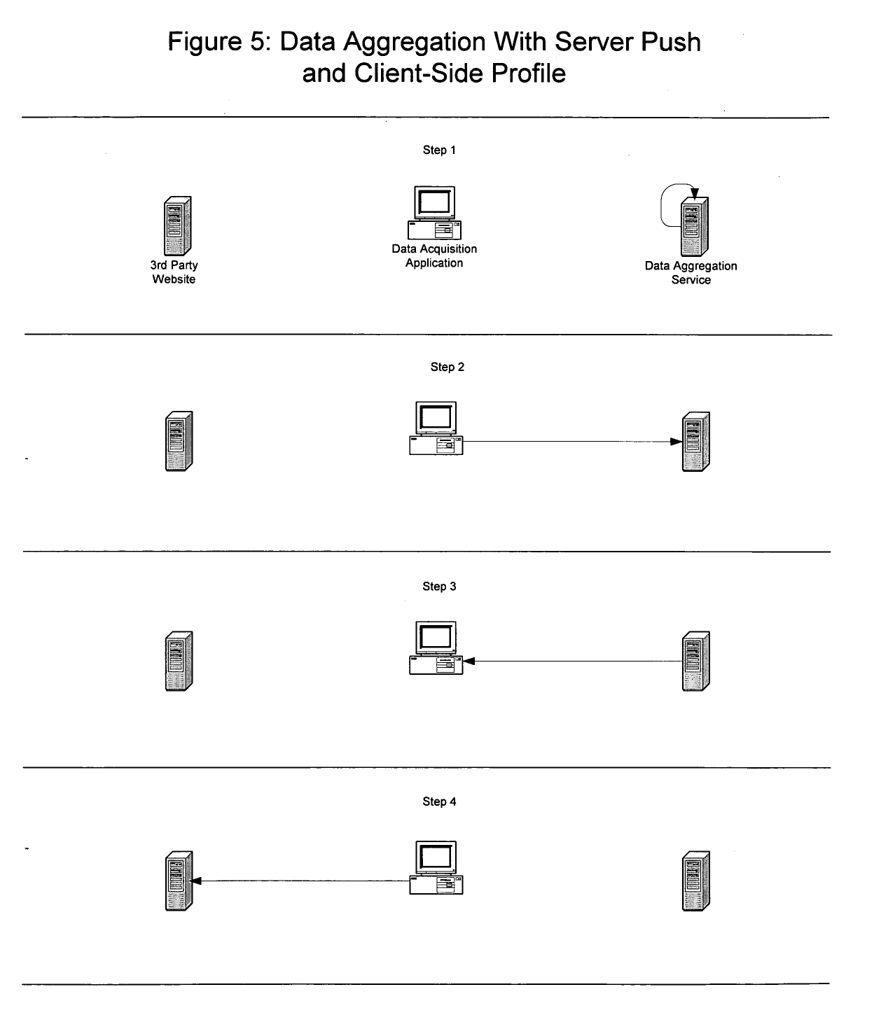

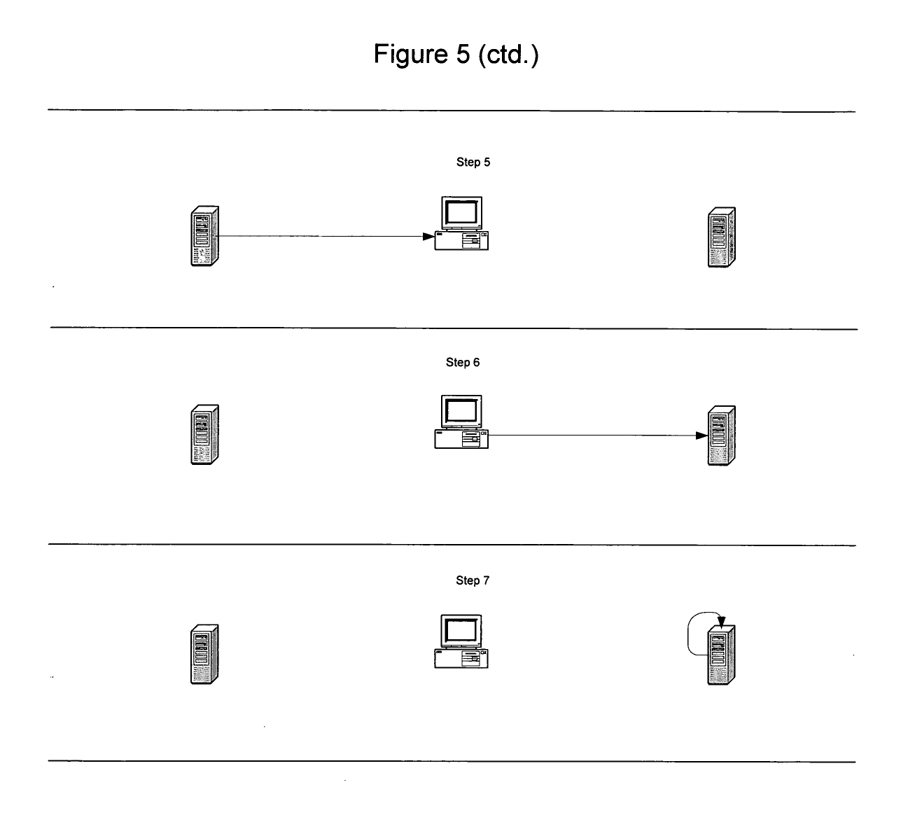

FIG. 5 is identical to FIG. 3 except that the end user profile resides on the client machine, not the Data Aggregation Service. For this reason, the Data Aggregation Service prepares a non-specific request to the Data Acquisition Application (in Step 1) that it then downloads to the Data Acquisition Service (in Step 3), perhaps after a delay designed to simulate human behavior. The Data Acquisition Service then combines the non-specific request with relevant preference profile information residing on the client machine to generate a specific request related to the end user's preference profile that it then sends to the 3rd Party Website (in Step 4), perhaps after a delay to simulate human behavior. As in FIGS. 3 & 4, these requests may be issued after the client machine logs into the 3rd party website (either by manual action by the end user or by computer-based retrieval of the end user's username, password, and/or any other necessary information).

FIGS. 6a through 6f describe server-side data storage & processing and its interaction with the Data Acquisition Application in greater detail.

In Step 1 (FIG. 6a), the Data Aggregation Service's Data Aggregation Application generates one or more requests for a end user's client based on that end user's profile and, possibly, based on: Data Collected From Data Acquisition Applications, other End User Profiles, Knowledge of 3rd Party Websites (especially how to create requests that generate desired responses), and Other Data.

In Step 2 (FIG. 6b), the Data Aggregation Application stores the generated request(s) in a Client-Specific Request Queue for pickup by the Data Acquisition Application.

In Step 3 (FIG. 6c), the Data Acquisition Application downloads the request(s) from its Client-Specific Request Queue OR the Data Aggregation Service's Data Aggregation Application pushes the request(s) from the Client-Specific Request Queue to the Data Acquisition Application. Then the Data Acquisition Application issues the request(s) to 3rd Party Website(s).

In Step 4 (FIG. 6d), the Data Acquisition Application receives responses from 3rd Party Website(s) and relays the responses (perhaps after processing and/or modification) to the Data Aggregation Service's Data Aggregation Application.

In Step 5 (FIG. 6e), the Data Aggregation Service's Data Aggregation Application stores any response(s) in the Data Aggregation Service database, perhaps after processing and/or modification by the Data Acquisition Application (as described in FIG. 6d) and perhaps after further processing and/or modification by the Data Aggregation Application where the processing and/or modification may depend in part on data already stored in the Data Aggregation Service database.

In Step 6 (FIG. 6f), we point out that Steps 1 through 5 may happen over and over again until there is no more data to acquire relevant to the end user's profile. We display only Step 1, but this is meant to indicate that the entire process may repeat.

FIGS. 7a through 7o show the entire process from an application and data standpoint.

FIG. 7a depicts the architecture from an application and data standpoint. The Client Machine consists of a Data Acquisition Application (that receives requests from the Data Aggregation Application, sends those requests to 3rd Party Websites and relays responses to the Data Aggregation Service's Data Aggregation Application) and a Client Interaction Application (that allows the end user to access data from the Data Aggregation Service through the End User Interaction Application). In practice, these applications may reside on two or more Client Machines. A Client Machine with a Data Acquisition Application need not also contain a Client Interaction Application.

FIG. 7b shows Step 1 in this process. The end user must use the Client Interaction Application to transmit to the End User Interaction Application one or more new or modified profiles.

FIG. 7c depicts Step 2, the storing of the end user's profile(s) in the Data Aggregation Service's database by the End User Interaction Application.

Once one or more end user profiles are stored in the Data Aggregation Service's database, the Data Aggregation Application can access these profiles in the database, as shown in FIG. 7d (Step 3).

After the Data Aggregation Application has retrieved one or more profiles from the database, it can combine them with other information to generate client-specific requests (as described in FIG. 6a). FIG. 7e shows these requests being passed to the Data Acquisition Application on the Client Machine (as described in FIGS. 6b and 6c). FIGS. 6a through 6c are combined in FIG. 7e as Step 4.

FIG. 7f (Step 5) shows the Data Acquisition Application issuing request(s) to 3rd Party Website(s).

FIG. 7g (Step 6) shows a 3rd Party Website returning a response to the Data Acquisition Application.

FIG. 7g* (optional Step 61/2) shows that a 3rd Party Website response triggers the Data Acquisition Application to issue one or more follow-on request(s). These requests-and-responses continue until the Data Acquisition Application is satisfied that it has received all relevant responses.

FIG. 7h (Step 7) shows the Data Acquisition Application returning response(s) to the Data Aggregation Application. These responses may have been transformed or modified by the Data Acquisition Application before being returned to the Data Aggregation Application.

FIG. 7i (Step 8) depicts the Data Aggregation Application storing the data it received from the Data Acquisition Application in the Data Aggregation Service database. The data received may have been transformed or modified by the Data Aggregation Application before being stored in the Data Aggregation Service database.

FIG. 7j (Step 9) shows that Steps 3 through 8 (i.e., FIGS. 7d through 7i) may repeat as many times as necessary to store all data relevant to the end user's profile(s). An alternative embodiment would be identical to everything described herein except that a single non-specific request sent by the Data Aggregation Application to the Data Acquisition Application could trigger a series of specific requests. For example, a non-specific request could be sent to the Data Acquisition Application asking it to search on a particular 3rd Party Website. The Data Acquisition Application might be smart enough to follow up on initial responses sent by the 3rd Party Website by issuing more requests of the 3rd Party Website, responses to which might be met with additional requests. Any or all data received in responses could be transmitted back to the Data Aggregation Service.

FIG. 7k (Step 10) shows the Client Interaction Application requesting information from the End User Interaction Application. This enables the end user to make use of data and information stored in the Data Aggregation Service. The End User Interaction Application may enable the end user to use data in many ways (access, view, modify, download, delete, etc.). The End User Interaction Application may also restrict the end user's access to a subset of the entire set of data residing in the Data Aggregation Service. Such restriction would in many cases be related to the end user's profile(s).

FIG. 7l (Step 11) depicts the End User Interaction Application requesting data from the Data Aggregation Service database.

FIG. 7m (Step 12) shows the database replying to the End User Interaction Application with data requested by the End User Interaction Application in Step 11 (FIG. 7l).

FIG. 7n (Step 13) shows the End User Interaction Application responding to the Client Interaction Application with a reply to its request in Step 10 (FIG. 7k). It is important to note that significant intelligence and functionality may be built into the Client Interaction Application that might allow it to reformat data, personalize it, allow the user to interact with it (such as zooming in and out of a map), etc. For example, the End User Interaction Application might send raw data in XML format to the Client Machine for the Client Interaction Application to parse and display according to formatting rules and code stored on the Client Machine. Also significant is the fact that the Client Interaction Application might have access to data not provided by the End User Interaction Application. For example, certain data returned from 3rd Party Websites to the Client Machine might be stored on the Client Machine and accessible to the Client Interaction Application whether or not that data was ever returned to the Data Aggregation Service. Storing information “locally” on the Client Machine will speed up the responsiveness of the Client Interaction Application and improve the responsiveness to user requests. Additionally, the Client Interaction Application may be able to take advantage of certain data that might not even be stored on either the Client Machine (by “caching” or “saving” it to memory and/or hard drive and/or other storage device(s)) or the Data Aggregation Service. Either the Client Machine or the Data Aggregation Service may have recorded a reference (in computer terminology, a “pointer,” “link” or “hyperlink”) to certain useful information stored on a 3rd Party Website(s). The Client Interaction Application might be able to access such information, integrate it with information stored on the Client Machine and/or the Data Aggregation Service and display the resulting information to the end user.

FIG. 7o (Step 14) shows that Steps 10 through 13 (i.e., FIGS. 7l through 7n) may repeat as many times as necessary to allow the Client Interaction Application to receive all information relevant to the end user.

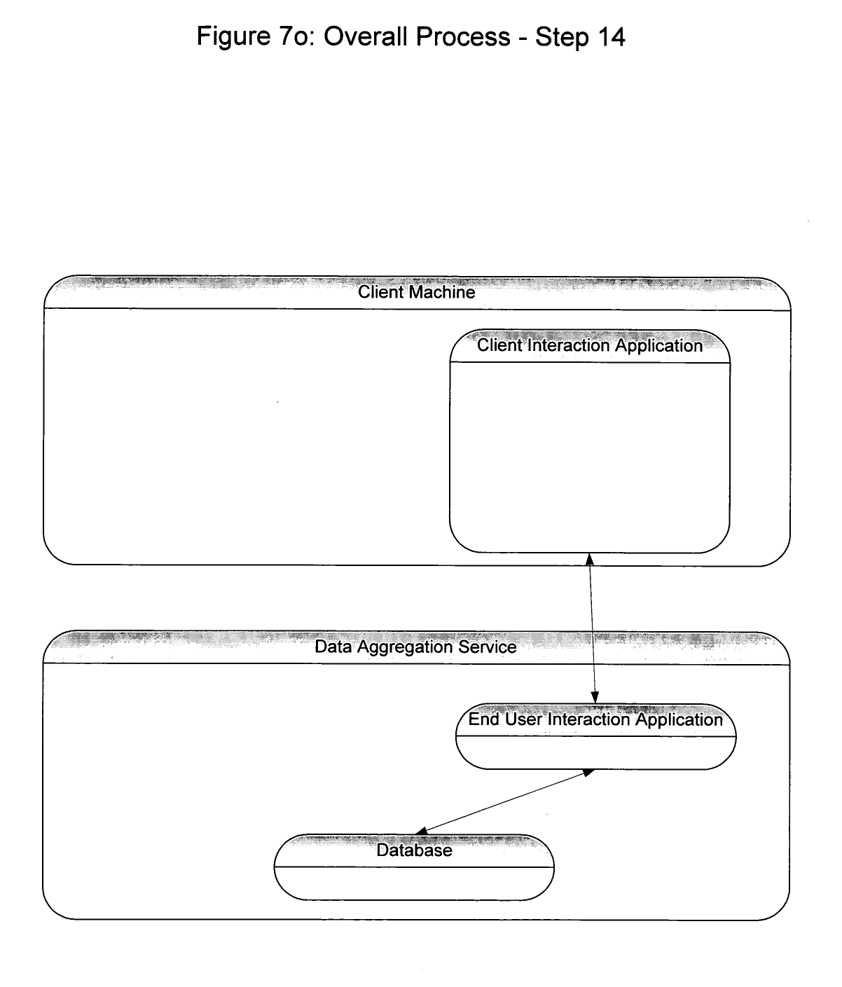

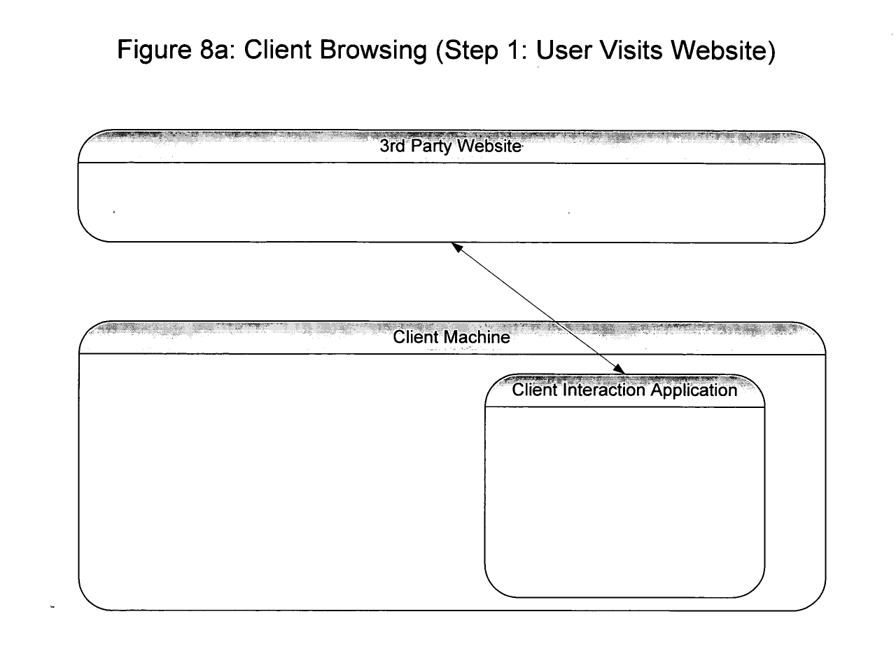

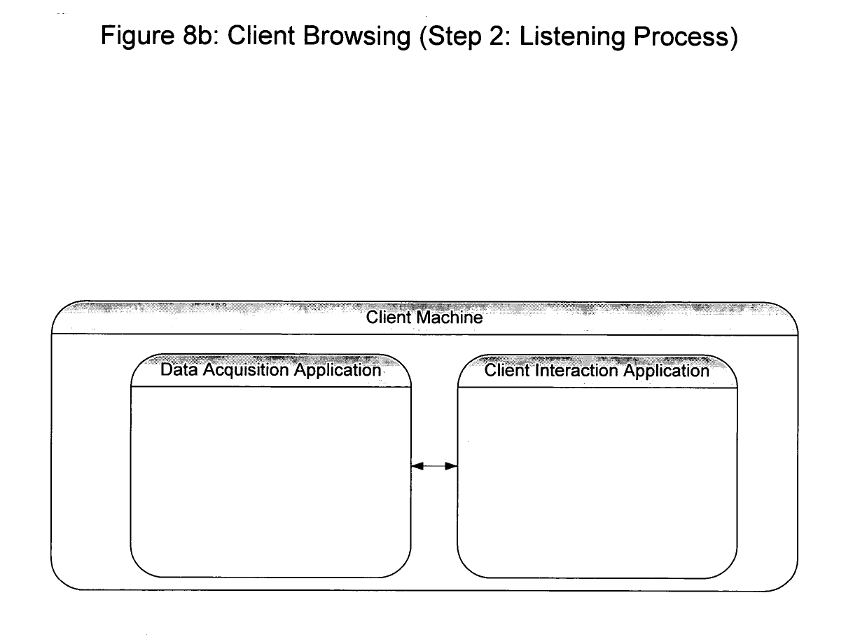

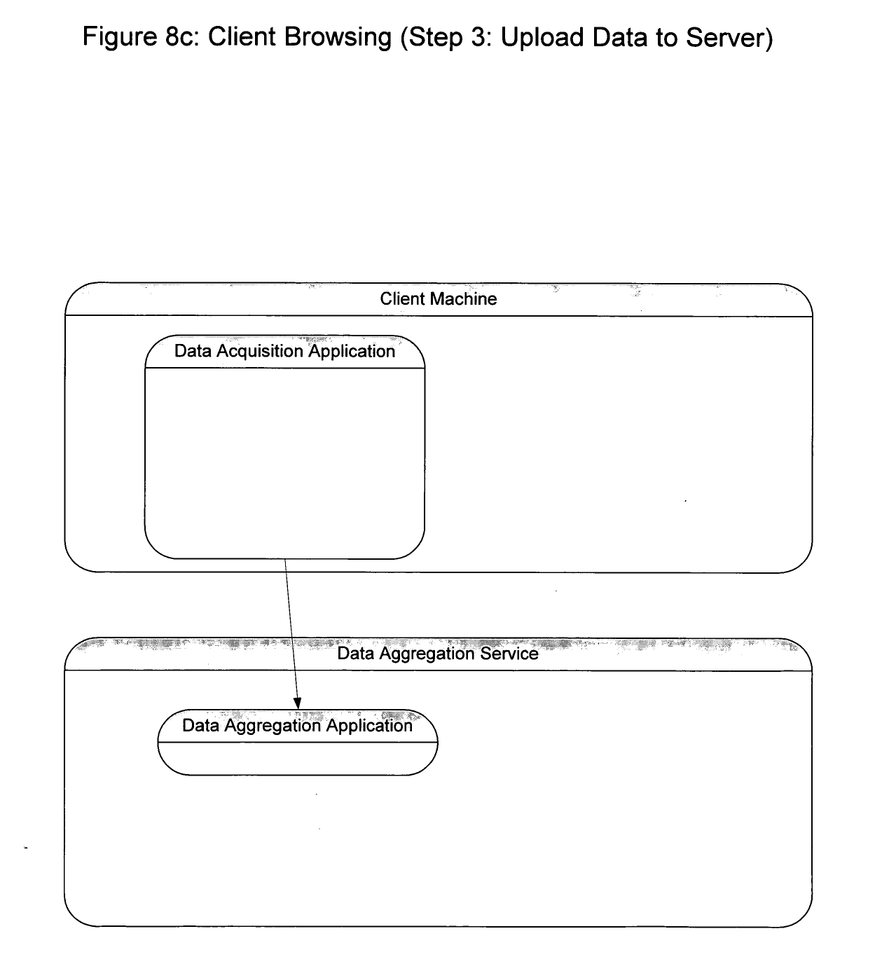

In FIGS. 8a through 8c, we describe another method for distributed data acquisition and aggregation in which the Data Acquisition Application monitors end users' Internet browsing sessions (or similar sessions in which end users traverse computer-based networks) and either forwards all information to the Data Aggregation Service for analysis/parsing or forwards whatever information appears in the browser that the Data Acquisition Application determines is or might be of interest to the Data Aggregation Service. End users might be permitted to turn on and/or off browser session monitoring by the Data Acquisition Application.

FIG. 8a (“Client Browsing, Step 1: User Visits Website”) represents a request by an end user for information from a 3rd Party Website and the receipt of a response or responses from the 3rd Party Website.

FIG. 8b (“Client Browsing, Step 2: Listening Process”) shows that the Data Acquisition Application runs a process that monitors information sent from and/or received by the end user (such HTTP requests and responses that are issued by and received by the end user's Internet browser). The Data Acquisition Application process might be “dumb” (in which case it might forward all information to the Data Aggregation Service) or “smart” (in which case it would attempt to determine which information might be relevant to and of interest to the Data Aggregation Service and forward only that information).

FIG. 8c (“Client Browsing, Step 3: Upload Data to Server”) shows the Data Acquisition Application forwarding information to the Data Aggregation Service.

FIGS. 8a through 8c represent only an alternative method for distributed data acquisition and aggregation. We will not again describe the way in which end users might interact with data stored on the Data Aggregation Service since this has already been described in detail in FIGS. 7k through 7o.

We developed in software and implemented several embodiments of this invention for the real estate industry. In our first implementation, created during Summer and Fall 2001, a downloadable standalone client-side application communicated with the server. In a later implementation, started in late 2001, a client-side Java applet runs within a browser window and communicates with the server.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention.

1. A method of collecting information on a data aggregation service comprising the steps of: a) a data acquisition application sending a request to a third party computer; b) said third party computer sending a response to said data acquisition application; c) said data acquisition application sending to a data aggregation service at least some of the information contained in said response; and d) said data aggregation service storing at least some of the information contained in said at least some of the information contained in said response received from said data acquisition application.

2. The method of claim 1 wherein said request to a third party computer initiates the process.

3. The method of claim 2 wherein said request to a third party computer incorporates information specific to said data acquisition application's owner or said data acquisition application's operator.

4. The method of claim 1 wherein said data aggregation service sends a request to said data acquisition application that said data acquisition application then utilizes to prepare said request to a third party computer.

5. The method of claim 4 wherein said request to said data acquisition application incorporates information known by said data aggregation service relating to said data acquisition application or said data acquisition application's owner or said data acquisition application's operator.

6. The method of claim 5 wherein said request to said data acquisition application contains sufficient information that said data acquisition application can generate said request to a third party computer without utilizing additional information specific to said data acquisition application's owner or said data acquisition application's operator.

7. The method of claim 4 wherein said data aggregation server increases the speed or efficiency of information collection by not issuing at least one said request to said data acquisition application that said data aggregation server predicts will return redundant information with high probability.

8. The method of claim 7 wherein said data aggregation application makes predictions by utilizing its knowledge of information already acquired and stored in said data aggregation server and/or information it possesses specific to one or more said data acquisition application owners or said data acquisition application operators.

9. The method of claim 6 wherein said data aggregation server increases the speed or efficiency of information collection by not issuing at least one said request to said data acquisition application that said data aggregation server predicts will return redundant information with high probability.

10. The method of claim 9 wherein said data aggregation application makes predictions by utilizing its knowledge of information already acquired and stored in said data aggregation server and/or information it possesses specific to one or more said data acquisition application owners or said data acquisition application operators.

11. A system for collecting information from one or more third party computers comprising: a data aggregation service; a data acquisition application; a third party computer; a data sharing connection between said data acquisition application and said third party computer capable of transmitting a request from said data acquisition application to said third party computer and capable of transmitting a response from said third party computer to said data acquisition application; and a data sharing connection between said data acquisition application and said data aggregation service capable of transmitting at least some of the information contained in said response from said data acquisition application to said data aggregation service.

12. The system of claim 11 wherein said data sharing connection between said data acquisition application and said data aggregation service also is capable of transmitting a request from said data aggregation service to said data acquisition application.

13. A method for facilitating automated acquisition of data from computer-based network data sources by means of one or more data aggregation servers and a distributed network of one or more client computers (each operated by and/or on behalf of one or more end users).
